(19) United States
(12) Patent Application Publication
(10) Pub. No.: US 2026/0299859 A1
(43) Pub. Date: Oct. 1, 2026

(54) SETTING METHOD FOR DISPLAY APPARATUS AND PROCESSING METHOD FOR INFORMATION PROCESSING APPARATUS

(71) Applicant: SEIKO EPSON CORPORATION, Tokyo (JP)

(72) Inventors: Katsuyoshi YAMAGUCHI, MATSUMOTO-SHI (JP); Koichiro OTA, OMACHI-SHI (JP); Toshiki FUJIMORI, CHINO-SHI (JP)

(21) Appl. No.: 19/629,709

(22) Filed: Mar. 26, 2026

(30) Foreign Application Priority Data
Mar. 27, 2025 (JP) 2025-053155

(51) Int. Cl. G06F 3/14

(52) U.S. Cl. CPC G06F 3/14

(57) ABSTRACT

According to an aspect of the present disclosure, there is provided a setting method for a display apparatus, including storing, with a first information processing apparatus, identification information of a fixture and setting history information including setting information of a first display apparatus in correlation with each other and communicating, with a second information processing apparatus connected to the first information processing apparatus via a network, with the fixture using near field communication. The first display apparatus and a second display apparatus different from the first display apparatus are attachable to the fixture.

The present application is based on, and claims priority from JP Application Serial Number 2025-053155, filed Mar. 27, 2025, the disclosure of which is hereby incorporated by reference herein in its entirety.

### BACKGROUND

### 1. Technical Field

The present disclosure relates to a setting method for a display apparatus and a processing method for an information processing apparatus.

### 2. Related Art

A management system disclosed in JP-A-2008-117227 includes a plurality of projectors, a server, and a plurality of personal computers (PCs). In the management system, all of the plurality of projectors, the server, and the plurality of PCs are connected to a network and are capable of communicating with one another. The server performs remote control, monitoring, and management for the projectors. Adapters and coupling shafts are coupled to housings of the projectors, whereby the projectors are attached to a ceiling.

JP-A-2008-117227 is an example of the related art.

The disclosure relating to JP-A-2008-117227 does not assume a case in which the projector attached to the ceiling is replaced because of failure and for the purpose of maintenance. For this reason, after the projector attached to the ceiling is replaced with another projector, setting work for the projector attached to the ceiling anew is a burden on a user of the projector or an operator who replaces the projector.

### SUMMARY

According to an aspect of the present disclosure, there is provided a setting method for a display apparatus, including: storing, with a first information processing apparatus, identification information of a fixture and setting history information including setting information of a first display apparatus in correlation with each other; and communicating, with a second information processing apparatus connected to the first information processing apparatus via a network, with the fixture using near field communication, wherein the first display apparatus and a second display apparatus different from the first display apparatus are attachable to the fixture.

According to an aspect of the present disclosure, there is provided a processing method for an information processing apparatus, including: storing identification information of a fixture and setting history information including setting information of a first display apparatus attachable to the fixture in correlation with each other; acquiring the identification information of the fixture, identification information of a second display apparatus different from the first display apparatus and attachable to the fixture, and setting information of the second display apparatus; and storing the setting information of the second display apparatus based on the setting history information in correlation with the identification information of the fixture.

According to an aspect of the present disclosure, there is provided a processing method for an information processing apparatus, including: storing identification information of a fixture and position information concerning relative positions of the fixture and a projection surface in correlation with each other; storing the identification information of the fixture and dimension information concerning a size of a projection image projected onto the projection surface in correlation with each other; acquiring the identification information of the fixture, identification information of a second display apparatus attachable to the fixture, and setting information of the second display apparatus; and storing the setting information of the second display apparatus based on the position information and the dimension information in correlation with the identification information of the fixture.

### BRIEF DESCRIPTION OF THE DRAWINGS

FIG. 1 is a block diagram illustrating an overall configuration of a display system.

FIG. 2 is a block diagram illustrating a configuration example of a first display apparatus.

FIG. 3 is a block diagram illustrating a configuration example of a second display apparatus.

FIG. 4 is a perspective view illustrating a configuration example of a fixture.

FIG. 5 is a block diagram illustrating a configuration example of a first information processing apparatus.

FIG. 6 is a block diagram illustrating a configuration example of a second information processing apparatus.

FIG. 7 is a sequence diagram illustrating an operation example of the display system according to a first embodiment.

FIG. 8 is a sequence diagram illustrating an operation example of the display system according to the first embodiment.

FIG. 9 is a block diagram illustrating a configuration example of a second display apparatus.

FIG. 10 is a block diagram illustrating a configuration example of a second information processing apparatus.

FIG. 11 is a sequence diagram illustrating an operation example of a display system according to a second embodiment.

FIG. 12 is a sequence diagram illustrating the operation example of the display system according to the second embodiment.

FIG. 13 is a block diagram illustrating a configuration example of a first information processing apparatus.

FIG. 14 is a sequence diagram illustrating an operation example of a display system.

FIG. 15 is a sequence diagram illustrating the operation example of the display system.

FIG. 16 is a sequence diagram illustrating the operation example of the display system.

FIG. 17 is a block diagram illustrating a configuration example of a first display apparatus.

FIG. 18 is a block diagram illustrating a configuration example of a second display apparatus.

FIG. 19 is a sequence diagram illustrating an operation example of a display system.

FIG. 20 is a sequence diagram illustrating the operation example of the display system.

FIG. 21 is a sequence diagram illustrating the operation example of the display system.

FIG. 22 is a block diagram illustrating a configuration example of a second display apparatus.

FIG. 23 is a sequence diagram illustrating an operation example of a display system.

FIG. 24 is a sequence diagram illustrating the operation example of the display system.

FIG. 25 is a sequence diagram illustrating the operation example of the display system.

### DESCRIPTION OF EMBODIMENTS

Hereinafter, embodiments for implementing the present disclosure are explained with reference to the drawings. In the respective figures, dimensions and scales of units are differentiated from actual ones as appropriate. Since embodiments explained below are preferred specific examples of the present disclosure, technically preferable various limitations are applied to the embodiments. However, the scope of the present disclosure is not limited to the embodiments unless there is particularly a description to the effect that the present disclosure is limited in the following explanation.

### 1: First Embodiment

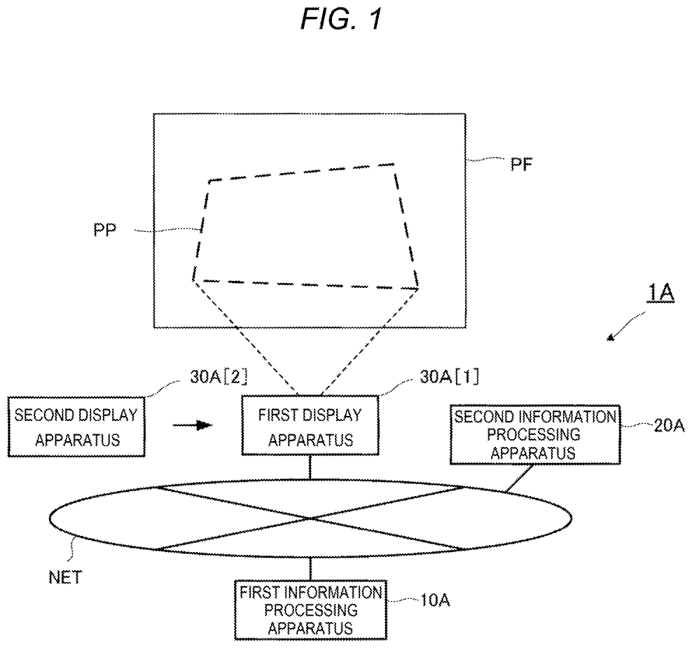

Hereinafter, a display system 1A according to a first embodiment is explained with reference to FIGS. 1 to 8.

### 1-1: Configuration of the First Embodiment

### 1-1-1: Overall Configuration

FIG. 1 is a block diagram illustrating an overall configuration of the display system 1A according to the present embodiment. The display system 1A includes a first information processing apparatus 10A, a second information processing apparatus 20A, a first display apparatus 30A[1], and a second display apparatus 30A[2].

In the display system 1A illustrated in FIG. 1, initially, the first information processing apparatus 10A, the second information processing apparatus 20A, and the first display apparatus 30A[1] are communicably connected to one another via a communication network NET. As an example, the first display apparatus 30A[1] is attached to, by a fixture 70 explained below, a ceiling or a wall of a space in which the first display apparatus 30A[1] is installed. Thereafter, a user or an operator of the first display apparatus 30A[1] detaches the first display apparatus 30A[1] from the ceiling or the wall and replaces the first display apparatus 30A[1] with the second display apparatus 30A[2]. After the first display apparatus 30A[1] is replaced with the second display apparatus 30A[2], the first information processing apparatus 10A, the second information processing apparatus 20A, and the second display apparatus 30A[2] are communicably connected to one another via the communication network NET.

The first display apparatus 30A[1] and the second display apparatus 30A[2] are, as an example, projection apparatuses including a projector 31 explained below. The first display apparatus 30A[1] and the second display apparatus 30A[2] project a projection image PP onto a projection surface PF. The projection surface PF is, as an example, a wall or a screen.

The first information processing apparatus 10A is a server that manages the first display apparatus 30A[1] and the second display apparatus 30A[2]. More specifically, as an example, the first information processing apparatus 10A manages various information including setting values of the first display apparatus 30A[1] and the second display apparatus 30A[2]. The first information processing apparatus 10A is, as an example, a PC.

The second information processing apparatus 20A is a terminal apparatus used by, at the time of the replacement, the user or the operator who replaces the first display apparatus 30A[1] with the second display apparatus 30A[2]. At the time of the replacement, the second information processing apparatus 20A reads information explained below from the second display apparatus 30A[2] and the fixture 70. The second information processing apparatus 20A transmits the read information to the first information processing apparatus 10A. The first information processing apparatus 10A transmits setting values of the second display apparatus 30A[2] to the second display apparatus 30A[2] based on the information received from the second information processing apparatus 20A. The second display apparatus 30A[2] updates the setting values using the setting values received from the first information processing apparatus 10A.

The second information processing apparatus 20A is, as an example, a smartphone or a tablet.

### 1-1-2: Configuration of the First Display Apparatus

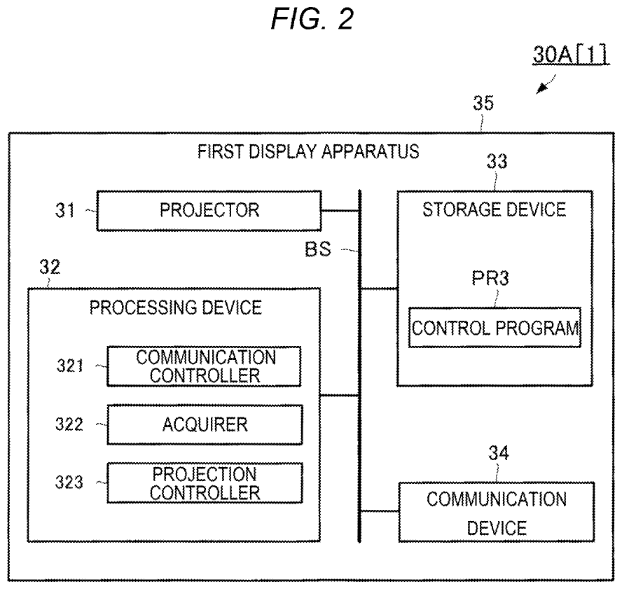

FIG. 2 is a block diagram illustrating a configuration example of the first display apparatus 30A[1].

The first display apparatus 30A[1] includes a projector 31, a processing device 32, a storage device 33, a communication device 34, and a housing 35. In the housing 35, the projector 31, the processing device 32, the storage device 33, and the communication device 34 are housed. Elements of the projector 31, the processing device 32, the storage device 33, and the communication device 34 are connected to one another via one or a plurality of buses BS for communicating information. Elements of the first display apparatus 30A[1] include one or a plurality of pieces of equipment. Some of the elements of the first display apparatus 30A[1] may be omitted.

The projector 31 is a device that projects the projection image PP acquired by an acquirer 322 explained below onto the projection surface PF. The projector 31 projects various images under control by the processing device 32. The projector 31 includes, for example, a light source, a liquid crystal panel, and a projection lens, modulates light emitted from the light source using the liquid crystal panel, and projects the modulated light onto the screen, the wall, or the like via the projection lens. The liquid crystal panel is an example of a light modulation element.

The processing device 32 is one or a plurality of processors that control the entire first display apparatus 30A[1]. The processing device 32 includes, for example, one or a plurality of chips. The processing device 32 includes, for example, a central processing unit (CPU) including an interface with peripheral devices, an arithmetic operation device, and a register. Some or all of the functions of the processing device 32 may be implemented by hardware such as a digital signal processor (DSP), an application specific integrated circuit (ASIC), a programmable logic device (PLD), or a field programmable gate array (FPGA). The processing device 32 executes various kinds of processing in parallel or sequentially.

The storage device 33 is a recording medium readable by the processing device 32 and stores a plurality of programs including a control program PR3 to be executed by the processing device 32. The storage device 33 stores a compiled-language program describing a procedure of arithmetic processing executed by the processing device 32. Further, the storage device 33 may store the projection image PP projected by the first display apparatus 30A[1].

The storage device 33 may include, for example, at least one of a read only memory (ROM), an erasable programmable ROM (EPROM), an electrically erasable programmable ROM (EEPROM), and a random access memory (RAM). The storage device 33 may be called register, cache, main memory, main storage device, or the like.

The communication device 34 is hardware serving as a transmission and reception device for communicating with other apparatuses. The communication device 34 is also called, for example, a network device, a network controller, a network card, or a communication module. The communication device 34 may include a connector for wired connection and may include an interface circuit corresponding to the connector. The communication device 34 may include a wireless communication interface. Examples of the connector for wired connection and the interface circuit include those conforming to wired LAN, IEEE 1394, and USB. Examples of the wireless communication interface include those conforming to wireless LAN, Bluetooth (registered trademark), and the like.

The processing device 32 functions as a communication controller 321, an acquirer 322, and a projection controller 323 by reading a control program PR3 from the storage device 33 and executing the control program PR3. The control program PR3 may be transmitted from, via the communication network NET, another apparatus such as the first information processing apparatus 10A that manages the first display apparatus 30A[1].

The communication controller 321 controls the communication device 34 to thereby cause the communication device 34 to transmit and receive various information and data to and from external apparatuses. The external apparatuses include the first information processing apparatus 10A. The external apparatuses may include the second information processing apparatus 20A.

The acquirer 322 acquires the projection image PP to be projected by the projector 31. As an example, the acquirer 322 may acquire the projection image PP stored in the storage device 33. Alternatively, as another example, the acquirer 322 may acquire the projection image PP from an external apparatus. The external apparatus may be, as an example, the first information processing apparatus 10A. Alternatively, the external apparatus may be, as another example, the second information processing apparatus 20A.

The projection controller 323 causes the projector 31 to project the projection image PP acquired by the acquirer 322 onto the projection surface PF.

### 1-1-3: Configuration of the Second Display Apparatus

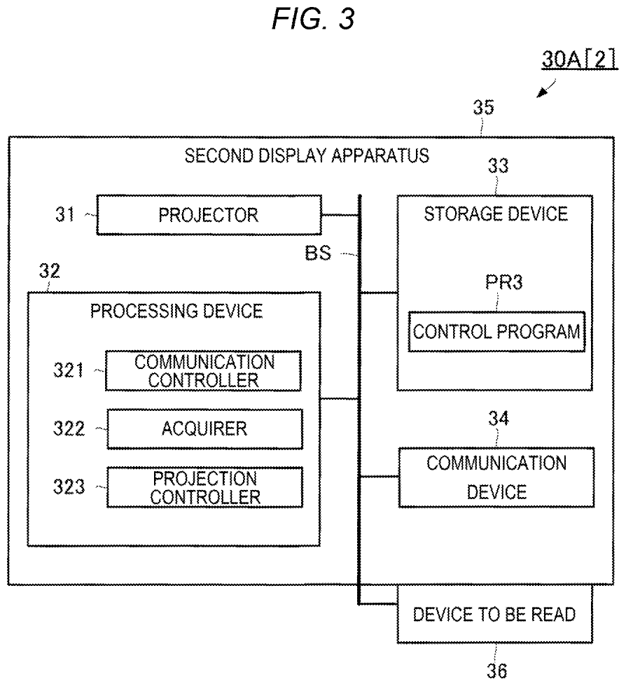

FIG. 3 is a block diagram illustrating a configuration example of the second display apparatus 30A[2]. In the present embodiment, the second display apparatus 30A[2] is, as an example, the display apparatus 30 having the same model number as the first display apparatus 30A[1]. For this reason, a configuration of the second display apparatus 30A[2] is basically the same as the configuration of the first display apparatus 30A[1]. Hereinafter, in order to simplify explanation, differences of the second display apparatus 30A[2] from the first display apparatus 30A[1] are mainly explained. Further, among elements provided in the second display apparatus 30A[2], the same elements as the elements provided in the first display apparatus 30A[1] are denoted by the same reference numerals and signs and explanation of functions of the elements is sometimes omitted.

The second display apparatus 30A[2] includes a device to be read 36 in addition to the elements provided in the first display apparatus 30A[1]. The device to be read 36 is, as an example, an IC tag. Information explained below is stored in the device to be read 36. The information stored in the device to be read 36 is read from a reading device 26 explained below serving as an external device. For this reason, the device to be read 36 is preferably installed on the surface of the housing 35. The device to be read 36 is preferably connected to a bus BS. However, the device to be read 36 may not be connected to the bus BS.

Identification information DI of the second display apparatus 30A[2] is stored in the device to be read 36.

An IP address of the second display apparatus 30A[2] is stored in the device to be read 36. More specifically, after the first display apparatus 30A[1] is detached from the fixture 70 and the second display apparatus 30A[2] is attached to the fixture 70, a power supply terminal and a network connection terminal are attached to the second display apparatus 30A[2] by a user or an operator of the second display apparatus 30A[2]. When the second display apparatus 30A[2] is turned on by the user or the operator and the network connection terminal is connected to the communication network NET, the IP address of the second display apparatus 30A[2] is determined. As an example, the IP address is stored in the device to be read 36 by the processing device 32 via the bus BS. The device to be read 36 stores the IP address stored by the processing device 32. As another example, the device to be read 36 may not be connected to the bus BS and the IP address of the second display apparatus 30A[2] set in advance may be stored in the device to be read 36.

An MAC address of the second display apparatus 30A[2] may be stored in the device to be read 36 instead of the IP address of the second display apparatus 30A[2].

The IP address and the MAC address are examples of “network address information”.

### 1-1-4: Configuration of the Fixture

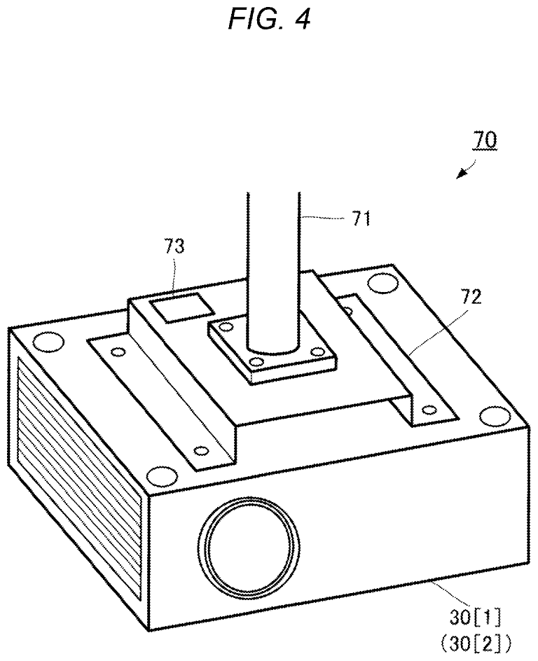

FIG. 4 is a perspective view illustrating a configuration example of the fixture 70. The fixture 70 includes an installation section 71, a fixing section 72, and a device to be read 73.

The installation section 71 is a member for installing the first display apparatus 30A[1] or the second display apparatus 30A[2] in a space. More specifically, the installation section 71 is a member for installing the first display apparatus 30A[1] or the second display apparatus 30A[2] at a predetermined position on a ceiling or a wall in the space. The shape of the installation section 71 is, as an example, a columnar shape illustrated in FIG. 4. However, the shape of the installation section 71 is not limited to the columnar shape.

The fixing section 72 is a member that fixes the first display apparatus 30A[1] or the second display apparatus 30A[2] to the installation section 71. In the present embodiment, as an example, the fixing section 72 fixes the first display apparatus 30A[1] or the second display apparatus 30A[2] to the installation section 71 at a predetermined angle. As an example, the predetermined angle is fixed.

The device to be read 73 is a device that stores identification information AI of the fixture 70. The device to be read 73 is, as an example, an IC tag, a barcode, or a QR code (registered trademark). The identification information AI stored in the device to be read 73 is read by a reading device 26 explained below serving as an external device. For this reason, the device to be read 73 is suitably installed on the surface of the fixture 70. In the example illustrated in FIG. 4, the device to be read 73 is installed on the surface of the fixing section 72. However, an installation part of the device to be read 73 is not limited to the surface of the fixing section 72. For example, the device to be read 73 may be installed on the surface of the installation section 71.

### 1-1-5: Configuration of the First Information Processing Apparatus

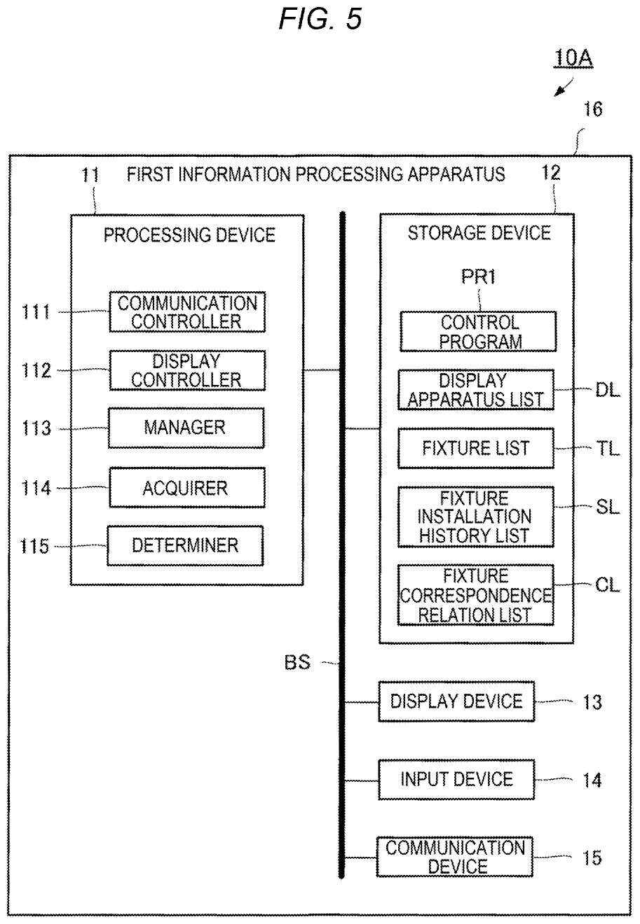

FIG. 5 is a block diagram illustrating a configuration example of the first information processing apparatus 10A. The first information processing apparatus 10A is typically the personal computer (PC) as explained above but is not limited thereto. The first information processing apparatus 10A includes a processing device 11, a storage device 12, a display device 13, an input device 14, a communication device 15, and a housing 16. In the housing 16, the processing device 11, the storage device 12, the display device 13, the input device 14, and the communication device 15 are housed. Elements of the processing device 11, the storage device 12, the display device 13, the input device 14, and the communication device 15 are connected to one another by one or a plurality of buses BS for communicating information.

The processing device 11 is a processor that controls the entire first information processing apparatus 10A. The processing device 11 includes, for example, one or a plurality of chips. The processing device 11 includes, for example, a central processing unit (CPU) including an interface with peripheral devices, an arithmetic operation device, and a register. Note that some or all of the functions of the processing device 11 may be implemented by hardware such as a DSP, an ASIC, a PLD, or an FPGA. The processing device 11 executes various kinds of processing in parallel or sequentially.

The storage device 12 is a recording medium that can be read and written by the processing device 11 and stores a plurality of programs including the control program PR1 to be executed by the processing device 11. The storage device 12 stores a display apparatus list DL, a fixture list TL, a fixture installation history list SL, and a fixture correspondence relation list CL.

The display apparatus list DL is a list concerning information including identification information DI of the display apparatus 30, and a setting value, a name, and a model number of the display apparatus 30 identified by the identification information DI, and a user name of a user who uses the display apparatus 30. The setting values are, as an example, one or more of a focal length, lens shift, a geometric correction value, lens zoom, and brightness of the display apparatus 30. Here, the setting values of the display apparatus 30 are an example of “setting information”.

The fixture list TL is a list concerning information including identification information AI of the fixture 70, position information and a model number of the fixture 70 identified by the identification information AI, and a user name of a user who uses the fixture 70. The position information of the fixture 70 is, as an example, position information concerning relative positions of the fixture 70 and the projection surface PF.

The fixture installation history list SL is a list indicating a history of the display apparatuses 30 attached to the fixture 70 identified by the identification information AI. As an example, the fixture installation history list SL is a list concerning information including the identification information AI of the fixture 70, update date and time information that is an attachment date and time of the display apparatus 30 that has been attached to the fixture 70 identified by the identification information AI, and setting values of the display apparatus 30. The setting values of the display apparatus 30 are an example of the “setting information”. The information included in the fixture installation history list SL is an example of “setting history information”.

When the second display apparatus 30A[2] is attached to the fixture 70, the “display apparatus 30 that has been attached to the fixture 70 identified by the identification information AI” includes the first display apparatus 30A[1].

The fixture correspondence relation list CL is a list indicating a correspondence relationship between the fixture 70 and the display apparatus 30 at the present time. As an example, the fixture correspondence relation list CL is a list concerning information including a set of the identification information AI of the fixture 70 and the identification information DI of the display apparatus 30.

The storage device 12 may include at least one of, for example, a ROM, an EPROM, an EEPROM, and a RAM. The storage device 12 may be called register, cache, main memory, main storage device, or the like.

The display device 13 is a device that displays an image and character information. The display device 13 may be a display device separate from the other elements of the first information processing apparatus 10A.

The input device 14 is equipment that receives operation from a user or an operator of the first information processing apparatus 10A. For example, the input device 14 includes a pointing device such as a keyboard, a touch pad, a touch panel, or a mouse. Here, when the input device 14 includes the touch panel, the input device 14 may also serve as the display device 13.

The communication device 15 is hardware serving as a transmission and reception device for performing communication with other apparatuses. The communication device 15 is also called, for example, network device, network controller, network card, or communication module. The communication device 15 may include a connector for wired connection and an interface circuit corresponding to the connector. The communication device 15 may include a wireless communication interface. Examples of the connector for wired connection and the interface circuit include those conforming to wired LAN, IEEE 1394, and USB. Examples of the wireless communication interface include those conforming to wireless LAN, Bluetooth (registered trademark), and the like.

The processing device 11 functions as a communication controller 111, a display controller 112, a manager 113, an acquirer 114, and a determiner 115 by reading the control program PR1 from the storage device 12 and executing the control program PR1.

The communication controller 111 controls the communication device 15 to thereby cause the communication device 15 to transmit and receive various information and data to and from external apparatuses. The external apparatuses include the second information processing apparatus 20A, the first display apparatus 30A[1], and the second display apparatus 30A[2].

The display controller 112 controls the display device 13.

As an example, the display controller 112 controls a display device 23 explained below provided in the second information processing apparatus 20A. As an example, the display controller 112 controls the display device 23 to cause the display device 23 to display a detailed screens concerning users of the first display apparatus 30A[1] and the second display apparatus 30A[2]. The detailed screen is, as an example, a list of display apparatuses 30 indicating what kind of display apparatus 30 the user is using.

The manager 113 manages the information included in the display apparatus list DL, the fixture list TL, the fixture installation history list SL, and the fixture correspondence relation list CL of the storage device 12.

The acquirer 114 acquires setting values of the first display apparatus 30A[1] stored in the display apparatus list DL of the storage device 12.

The determiner 115 determines whether the identification information DI of the second display apparatus 30A[2] received from the second information processing apparatus 20A is registered in the display apparatus list DL.

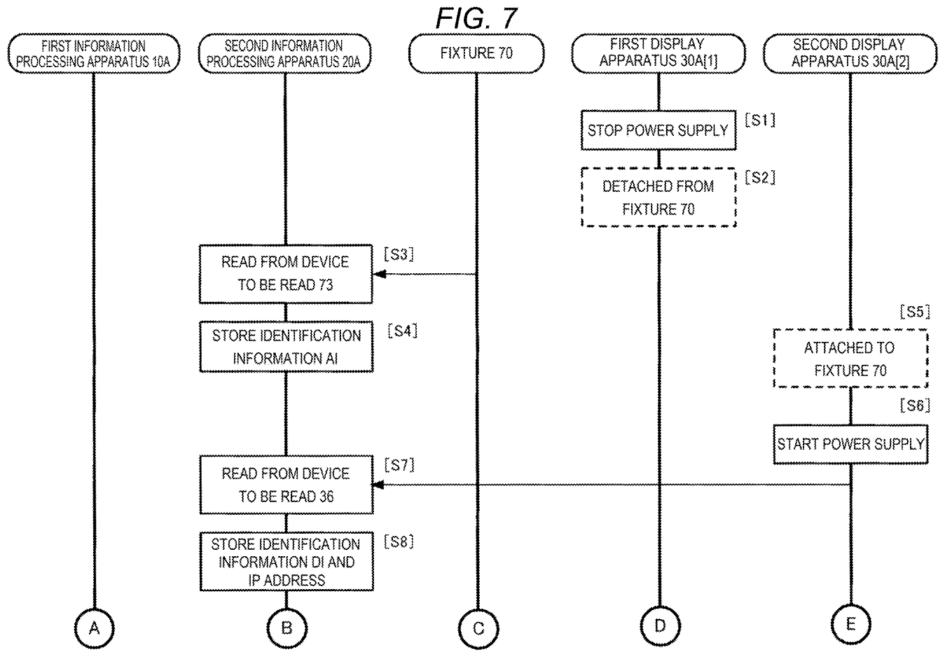

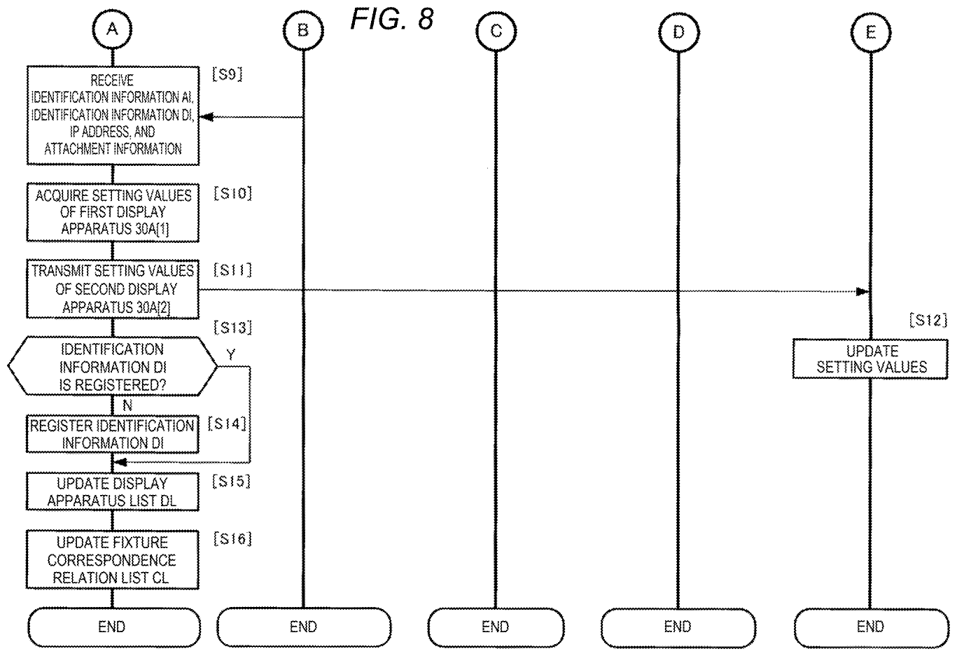

Details of operations of the manager 113, the acquirer 114, and the determiner 115 are explained below with reference to FIGS. 7 and 8.

### 1-1-6: Configuration of the Second Information Processing Apparatus

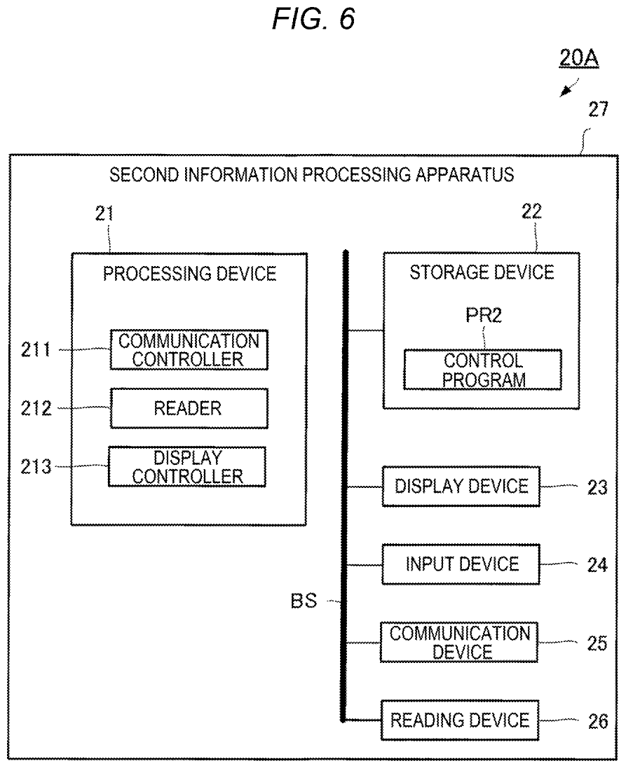

FIG. 6 is a block diagram illustrating a configuration example of the second information processing apparatus 20A. The second information processing apparatus 20A is typically the smartphone or the tablet as explained above but is not limited thereto. The second information processing apparatus 20A includes a processing device 21, a storage device 22, a display device 23, an input device 24, a communication device 25, a reading device 26, and a housing 27. In the housing 27, the processing device 21, the storage device 22, the display device 23, the input device 24, the communication device 25, and the reading device 26 are housed. Elements of the processing device 21, the storage device 22, the display device 23, the input device 24, the communication device 25, and the reading device 26 are connected to one another by one or a plurality of buses BS for communicating information.

The processing device 21 is a processor that controls the entire second information processing apparatus 20A. The processing device 21 includes, for example, one or a plurality of chips. The processing device 21 includes, for example, a central processing unit (CPU) including an interface with peripheral devices, an arithmetic device, a register, and the like. Note that some or all of the functions of the processing device 21 may be implemented by hardware such as a DSP, an ASIC, a PLD, or an FPGA. The processing device 21 executes various kinds of processing in parallel or sequentially.

The storage device 22 is a recording medium that can be read and written by the processing device 21 and stores a plurality of programs including a control program PR2 to be executed by the processing device 21.

The storage device 22 may include at least one of, for example, a ROM, an EPROM, an EEPROM, and a RAM. The storage device 22 may be called register, cache, main memory, main storage device, or the like.

The display device 23 is a device that displays an image and character information. The display device 23 may be a display device separate from the other elements of the second information processing apparatus 20A.

The input device 24 is a device that receives operation from a user or an operator of the second information processing apparatus 20A. For example, the input device 24 includes a pointing device such as a keyboard, a touch pad, a touch panel, or a mouse. Here, when the input device 24 includes the touch panel, the input device 24 may also serve as the display device 23.

The communication device 25 is hardware serving as a transmitting and receiving device for communication with the other apparatuses. The communication device 25 is also called, for example, network device, network controller, network card, or communication module. The communication device 25 may include a connector for wired connection and may include an interface circuit corresponding to the connector. The communication device 25 may include a wireless communication interface. Examples of the connector for wired connection and the interface circuit include those conforming to wired LAN, IEEE 1394, and USB. Examples of the wireless communication interface include those conforming to wireless LAN, Bluetooth (registered trademark), and the like.

The reading device 26 is a device for reading the information stored in the device to be read 36 provided in the second display apparatus 30A[2] and information stored in the device to be read 73 provided in the fixture 70. As an example, the reading device 26 communicates with the device to be read 36 provided in the second display apparatus 30A[2] using near field communication to thereby read the information stored in the device to be read 36. Similarly, as an example, the reading device 26 communicates with the device to be read 73 provided in the fixture 70 using the near field communication to thereby read the information stored in the device to be read 73. The near field communication described above conforms to a near field communication (NFC) standard as an example.

The processing device 21 functions as a communication controller 211, a reader 212, and a display controller 213 by reading the control program PR2 from the storage device 22 and executing the control program PR2.

The communication controller 211 controls the communication device 25 to thereby cause the communication device 25 to transmit and receive various information and data to and from external apparatuses. The external apparatuses include the first information processing apparatus 10A.

The reader 212 controls the reading device 26 to thereby cause the reading device 26 to read the information stored in the device to be read 36 provided in the second display apparatus 30A[2] and the information stored in the device to be read 73 provided in the fixture 70.

The display controller 213 controls the display device 23.

### 1-2: Operation in the First Embodiment

FIGS. 7 and 8 are sequence diagrams illustrating an operation example of the display system 1A according to the first embodiment. Among steps explained below, steps that are manually performed and have low relevance to internal processing of the apparatuses are indicated by dotted line boxes in FIGS. 7 and 8.

In step S1, the first display apparatus 30A[1] receives power supply stop operation from the user or the operator. The first display apparatus 30A[1] stops a power supply in response to the power supply stop operation received from the user or the operator.

In step S2, the first display apparatus 30A[1] is detached from the fixture 70 by the user or the operator. At this time, the power supply terminal and the network connection terminal are also detached from the first display apparatus 30A[1] by the user or the operator.

In step S3, the processing device 21 provided in the second information processing apparatus 20A functions as the reader 212. The processing device 21 reads the identification information AI of the fixture 70 from the device to be read 73 provided in the fixture 70.

In step S4, the storage device 22 provided in the second information processing apparatus 20A stores the identification information AI read in step S3.

In step S5, the second display apparatus 30A[2] is attached to the fixture 70 by the user or the operator. At this time, the power supply terminal and the network connection terminal are attached to the second display apparatus 30A[2] by the user or the operator.

In step S6, the second display apparatus 30A[2] receives power supply start operation from the user or the operator. The second display apparatus 30A[2] starts a power supply in response to the power supply start operation received from the user or the operator.

In step S7, the processing device 21 provided in the second information processing apparatus 20A functions as the reader 212. The processing device 21 reads the identification information DI and the IP address of the second display apparatus 30A[2] from the device to be read 36 provided in the second display apparatus 30A[2].

In step S8, the storage device 22 provided in the second information processing apparatus 20A stores the identification information DI and the IP address read in step S7.

In step S9, the processing device 21 provided in the second information processing apparatus 20A functions as the communication controller 211. The processing device 21 transmits, to the first information processing apparatus 10A, the identification information AI of the fixture 70, the identification information DI of the second display apparatus 30A[2], the IP address of the second display apparatus 30A[2], and attachment information indicating that the second display apparatus 30A[2] has been attached to the fixture 70.

The processing device 11 provided in the first information processing apparatus 10A functions as the communication controller 111. The processing device 11 receives, from the second information processing apparatus 20A, the identification information AI of the fixture 70, the identification information DI of the second display apparatus 30A[2], the IP address of the second display apparatus 30A[2], and attachment information indicating that the second display apparatus 30A[2] has been attached to the fixture 70.

In step S10, the processing device 11 provided in the first information processing apparatus 10A functions as the acquirer 114. The processing device 11 acquires setting values of the first display apparatus 30A[1] by referring to the fixture installation history list SL using the identification information AI received in step S9.

In step S11, the processing device 11 provided in the first information processing apparatus 10A functions as the communication controller 111. The processing device 11 transmits the setting values of the first display apparatus 30A[1] acquired in step S10 to the second display apparatus 30A[2] as setting values of the second display apparatus 30A[2]. At this time, the processing device 11 transmits the setting values of the second display apparatus 30A[2] to the second display apparatus 30A[2] using the IP address of the second display apparatus 30A[2] received in step S9.

The processing device 32 provided in the second display apparatus 30A[2] functions as the communication controller 321. The processing device 32 receives the setting values of the second display apparatus 30A[2] from the first information processing apparatus 10A.

The storage device 33 provided in the second display apparatus 30A[2] stores setting information including the setting values received from the first information processing apparatus 10A. The setting information is correlated with the identification information AI of the fixture 70 and is generated based on information included in the fixture installation history list SL. The information included in the fixture installation history list SL includes setting information of the first display apparatus 30A[1]. The information included in the fixture installation history list SL is an example of the “setting history information” as explained above.

In step S12, the processing device 32 provided in the second display apparatus 30A[2] updates the setting values of the second display apparatus 30A[2] using the setting values received in step S11.

In step S13, the processing device 11 provided in the first information processing apparatus 10A functions as the determiner 115. The processing device 11 determines whether the identification information DI of the second display apparatus 30A[2] received in step S9 is registered in the display apparatus list DL. When the identification information DI of the second display apparatus 30A[2] is registered in the display apparatus list DL (“Y” in step S13), the processing device 11 executes processing in step S15. When the identification information DI of the second display apparatus 30A[2] is not registered in the display apparatus list DL (“N” in step S13), the processing device 11 executes processing in step S14.

In step S14, the processing device 11 provided in the first information processing apparatus 10A functions as the manager 113. The processing device 11 registers the identification information DI of the second display apparatus 30A[2] in the display apparatus list DL.

In step S15, the processing device 11 provided in the first information processing apparatus 10A functions as the manager 113. The processing device 11 updates the display apparatus list DL by writing, as setting values corresponding to the identification information DI of the second display apparatus 30A[2] in the display apparatus list DL, the setting values transmitted to the second display apparatus 30A[2] in step S11.

In step S16, the processing device 11 provided in the first information processing apparatus 10A functions as the manager 113. The processing device 11 updates the fixture correspondence relation list CL by writing, in the fixture correspondence relation list CL, the identification information DI of the second display apparatus 30A[2] as the identification information DI of the display apparatus 30 correlated with the identification information AI of the fixture 70 in the fixture correspondence relation list CL.

Note that the order of the operations in steps S1 to S16 in FIGS. 7 and 8 may be changed as appropriate within a range in which an operation in the entire display system 1A is not hindered.

In the sequence explained above, step S1 and step S2 are equivalent to a “detachment procedure for the first display apparatus 30A[1]”. Steps S3 and S4 are equivalent to a “reading procedure for the fixture 70”. Steps S5 and S6 are equivalent to an “attachment procedure for the second display apparatus 30A[2]”. Steps S7 to S16 are equivalent to a “setting parameter determination procedure for the second display apparatus 30A[2]”.

### 2: Second Embodiment

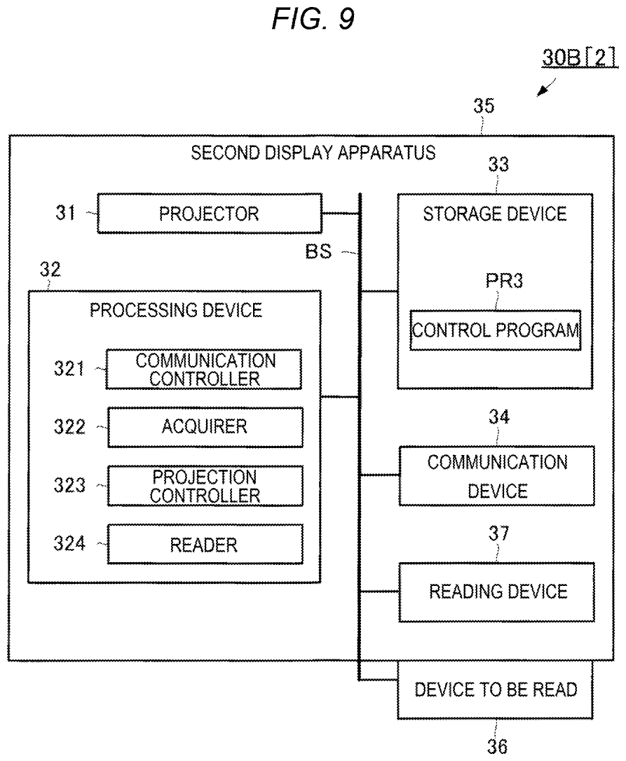

Hereinafter, a display system 1B according to a second embodiment is explained with reference to FIGS. 9 to 12. In order to simplify the explanation, differences of the display system 1B according to the second embodiment from the display system 1A according to the first embodiment are mainly explained below. Among elements provided in the display system 1B according to the second embodiment, the same elements as the elements provided in the display system 1A according to the first embodiment are denoted by the same reference numerals and signs and explanation of functions of the elements is sometimes omitted.

In the display system 1A according to the first embodiment, the first information processing apparatus 10A acquires the IP address of the second display apparatus 30A[2] from the second display apparatus 30A[2] via the second information processing apparatus 20A. Then, the first information processing apparatus 10A transmits the setting information of the second display apparatus 30A[2] to the second display apparatus 30A[2] via the communication network NET based on the IP address.

On the other hand, in the display system 1B according to the present embodiment, the first information processing apparatus 10A outputs setting information of a second display apparatus 30B[2] to the second display apparatus 30B[2] via a second information processing apparatus 20B.

### 2-1: Configuration in the Second Embodiment

### 2-1-1: Overall Configuration

Compared with the display system 1A according to the first embodiment, the display system 1B according to the present embodiment includes the second information processing apparatus 20B instead of the second information processing apparatus 20A and includes the second display apparatus 30B[2] instead of the second display apparatus 30A[2]. In other respects, an overall configuration of the display system 1B according to the present embodiment is the same as the overall configuration of the display system 1A according to the first embodiment. Therefore, illustration of the overall configuration is omitted.

Hereinafter, the second information processing apparatus 20B and the second display apparatus 30B[2], which are the differences from the display system 1A according to the first embodiment, are mainly explained.

### 2-1-2: Configuration of the Second Display Apparatus

FIG. 9 is a block diagram illustrating a configuration example of the second display apparatus 30B[2]. The second display apparatus 30B[2] includes a reading device 37 and a reader 324 in addition to the elements provided in the second display apparatus 30A[2] according to the first embodiment.

Unlike the device to be read 36 provided in the second display apparatus 30A[2] according to the first embodiment, the device to be read 36 provided in the second display apparatus 30B[2] does not always store an IP address of the second display apparatus 30B[2].

The reading device 37 is a device for reading information stored in a device to be read 28 explained below provided in the second information processing apparatus 20B. As an example, the reading device 37 communicates with the device to be read 28 provided in the second information processing apparatus 20B using near field communication to thereby read information stored in the device to be read 28. The near field communication described above conforms to the NFC standard as an example.

The reader 324 controls the reading device 37 to thereby cause the reading device 37 to read the information stored in the device to be read 28 provided in the second information processing 20B and the information stored in the device to be read 73 provided in the fixture 70.

### 2-1-3: Configuration of the Second Information Processing Apparatus

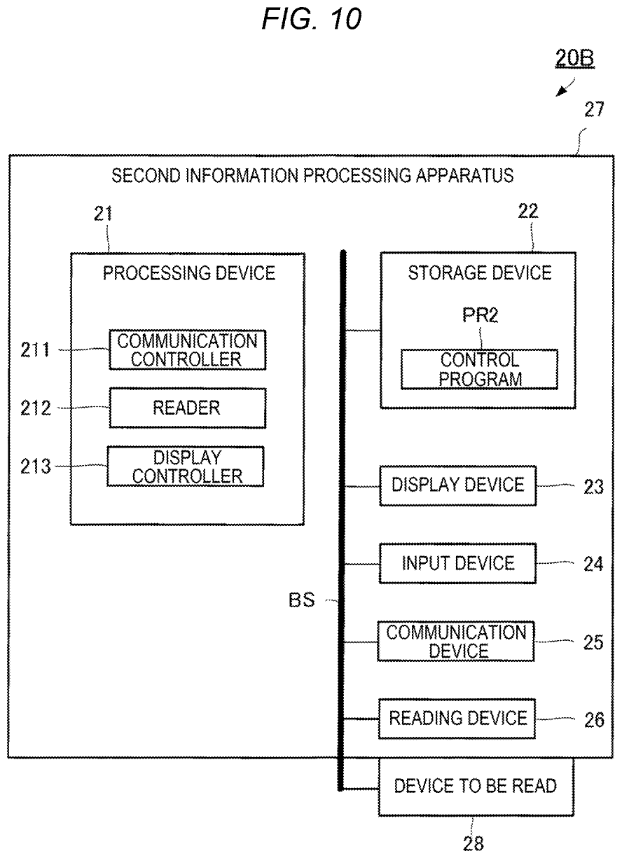

FIG. 10 is a block diagram illustrating a configuration example of the second information processing apparatus 20B. The second information processing apparatus 20B includes the device to be read 28 in addition to the elements provided in the second information processing apparatus 20A according to the first embodiment.

The communication controller 211 provided in the second information processing apparatus 20B communicates with the first information processing apparatus 10A to thereby receive setting information of the second display apparatus 30B[2]. The setting information includes setting values of the second display apparatus 30B[2].

The device to be read 28 is a device that stores setting information of the second display apparatus 30B[2]. As an example, the setting information is stored in the device to be read 28 by the processing device 21 via the bus BS. The device to be read 28 is, as an example, an IC tag. The setting information stored in the device to be read 28 is read by the reading device 37 serving as an external device. For this reason, the device to be read 28 is suitably installed on the surface of the second information processing apparatus 20B. However, an installation part of the device to be read 28 is not limited to the surface of the second information processing apparatus 20B. For example, the display device 23 may also serve as the device to be read 28. In this case, as an example, a barcode or a QR code (registered trademark) indicating the setting information of the second display apparatus 30B[2] is displayed on the display device 23. The reading device 37 acquires the setting information of the second display apparatus 30B[2] by reading the barcode or the QR code.

### 2-2: Operation in the Second Embodiment

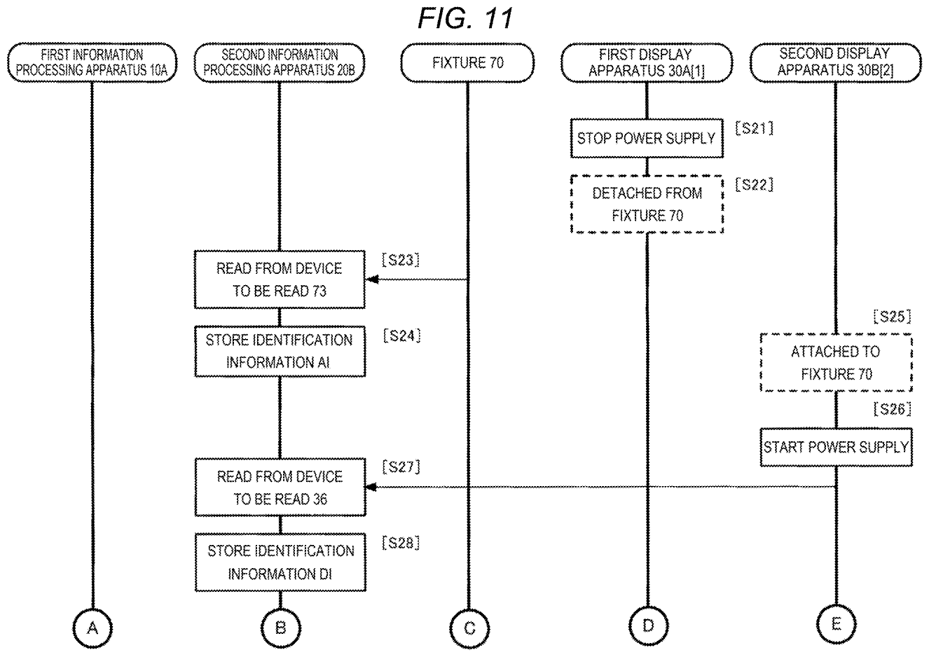

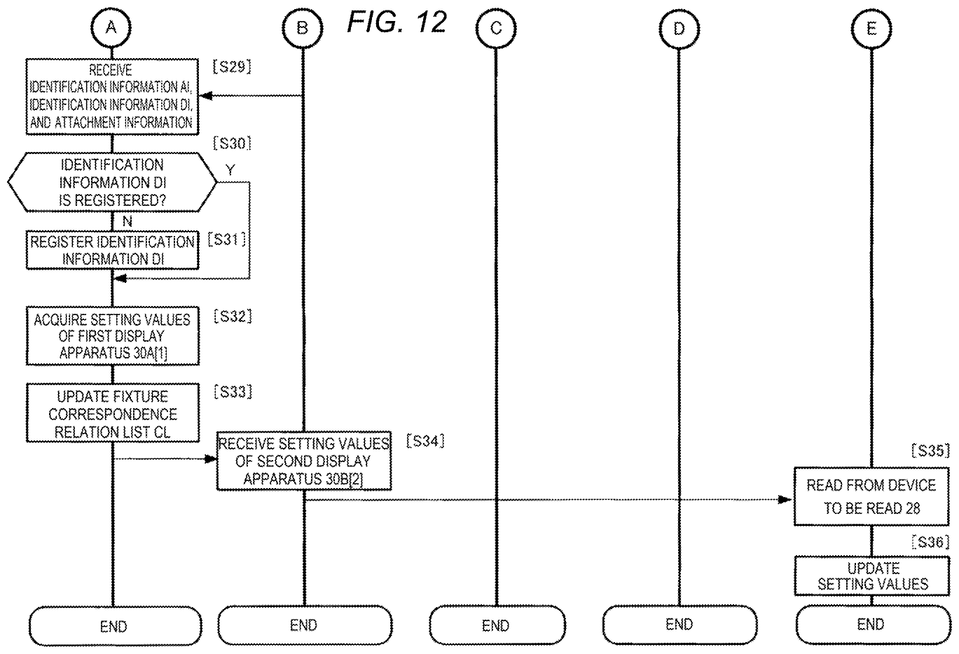

FIGS. 11 and 12 are sequence diagrams illustrating an operation example of the display system 1B according to the second embodiment. Among steps explained below, steps that are manually performed and have low relevance to internal processing of the apparatuses are indicated by dotted line boxes in FIGS. 11 and 12.

Among operations illustrated in FIGS. 11 and 12, steps S21 to S26 are the same as steps S1 to S6 among the operations in the first embodiment illustrated in FIGS. 7 and 8. Therefore, explanation of the steps is omitted.

In step S27, the processing device 21 provided in the second information processing apparatus 20B functions as the reader 212. The processing device 21 reads the identification information DI of the second display apparatus 30B[2] from the device to be read 36 provided in the second display apparatus 30B[2].

In step S28, the storage device 22 provided in the second information processing apparatus 20B stores the identification information DI read in step S27.

In step S29, the processing device 21 provided in the second information processing apparatus 20B functions as the communication controller 211. The processing device 21 transmits, to the first information processing apparatus 10A, the identification information AI of the fixture 70, the identification information DI of the second display apparatus 30B[2], and attachment information indicating that the second display apparatus 30B[2] has been attached to the fixture 70.

The processing device 11 provided in the first information processing apparatus 10A functions as the communication controller 111. The processing device 11 receives, from the second information processing apparatus 20B, the identification information AI of the fixture 70, the identification information DI of the second display apparatus 30B[2], and the attachment information indicating that the second display apparatus 30B[2] has been attached to the fixture 70.

In step S30, the processing device 11 provided in the first information processing apparatus 10A functions as the determiner 115. The processing device 11 determines whether the identification information DI of the second display apparatus 30B[2] received in step S29 is registered in the display apparatus list DL. When the identification information DI of the second display apparatus 30B[2] is registered in the display apparatus list DL (“Y” in step S30), the processing device 11 executes processing in step S32. When the identification information DI of the second display apparatus 30B[2] is not registered in the display apparatus list DL (“N” in step S30), the processing device 11 executes processing in step S31.

In step S31, the processing device 11 provided in the first information processing apparatus 10A functions as the manager 113. The processing device 11 registers the identification information DI of the second display apparatus 30B[2] in the display apparatus list DL.

In step S32, the processing device 11 provided in the first information processing apparatus 10A functions as the acquirer 114. The processing device 11 acquires setting values of the first display apparatus 30A[1] by referring to the fixture installation history list SL using the identification information AI received in step S29. In step S32, the processing device 11 functions as the manager 113. The processing device 11 updates the display apparatus list DL by writing the acquired setting values as setting values corresponding to the identification information DI of the second display apparatus 30B[2] in the display apparatus list DL.

In step S33, the processing device 11 provided in the first information processing apparatus 10A functions as the manager 113. The processing device 11 updates the fixture correspondence relation list CL by writing the identification information DI of the second display apparatus 30B[2] as the identification information DI of the display apparatus 30 correlated with the identification information AI of the fixture 70 in the fixture correspondence relation list CL.

In step S34, the processing device 11 provided in the first information processing apparatus 10A functions as the communication controller 111. In step S34, the processing device 11 transmits the setting values written in the display apparatus list DL to the second information processing apparatus 20B as setting values of the second display apparatus 30B[2].

The processing device 21 provided in the second information processing apparatus 20B functions as the communication controller 211. The processing device 21 receives the setting values of the second display apparatus 30B[2] from the first information processing apparatus 10A.

In step S35, the processing device 32 provided in the second display apparatus 30B[2] functions as the reader 324. The processing device 32 reads the setting values of the second display apparatus 30B[2] from the device to be read 28 provided in the second information processing apparatus 20B.

In step S36, the processing device 32 provided in the second display apparatus 30B[2] updates the setting values of the second display apparatus 30B[2] using the setting values read in step S35.

Note that the order of the operations in steps S21 to S36 in FIGS. 11 and 12 may be changed as appropriate within a range in which an operation in the entire display system 1B is not hindered.

In the sequence explained above, step S21 and step S22 are equivalent to the “detachment procedure for the first display apparatus 30A[1]”. Step S23 and step S24 are equivalent to the “reading procedure for the fixture 70”. Step S25 and step S26 are equivalent to an “attachment procedure for the second display apparatus 30B[2]”. Steps S27 to S36 are equivalent to a “setting parameter determination procedure of the second display apparatus 30B[2]”.

That is, in the sequence according to the first embodiment and the sequence according to the second embodiment, the “setting parameter determination procedure for the second display apparatus 30A[2]” and the “setting parameter determination procedure for the second display apparatus 30B[2]” are different and, on the other hand, the other procedures are the same.

### 3: Third Embodiment

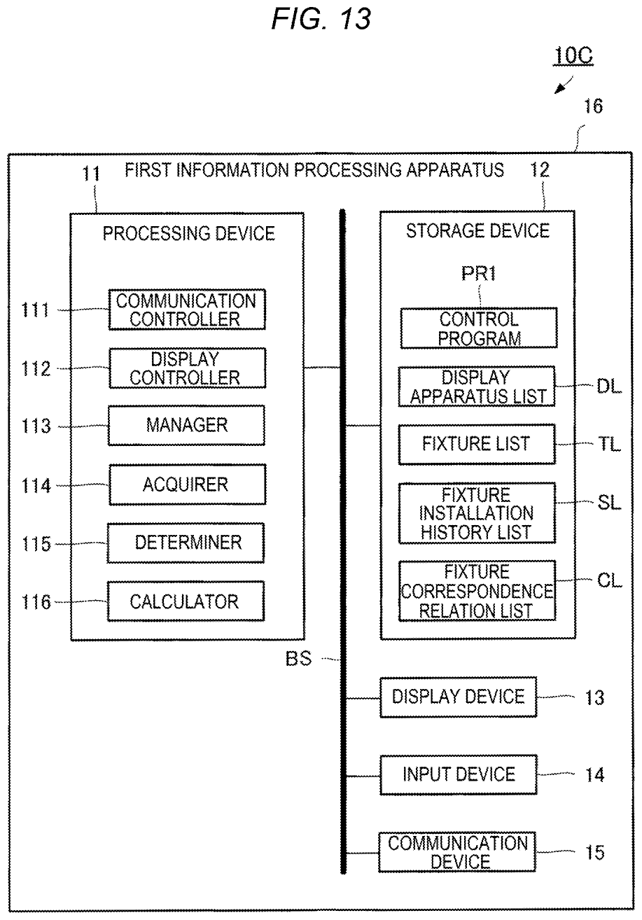

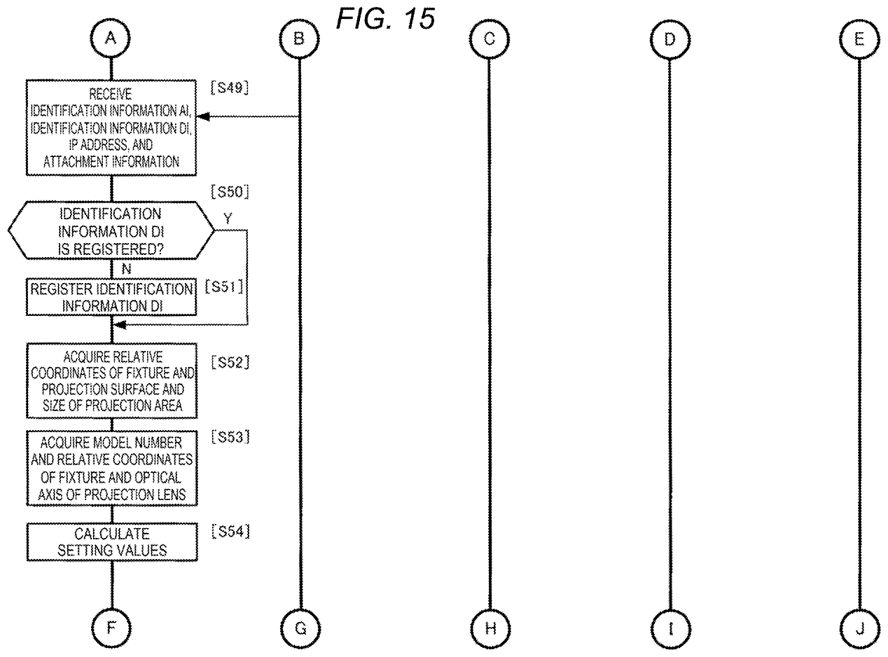

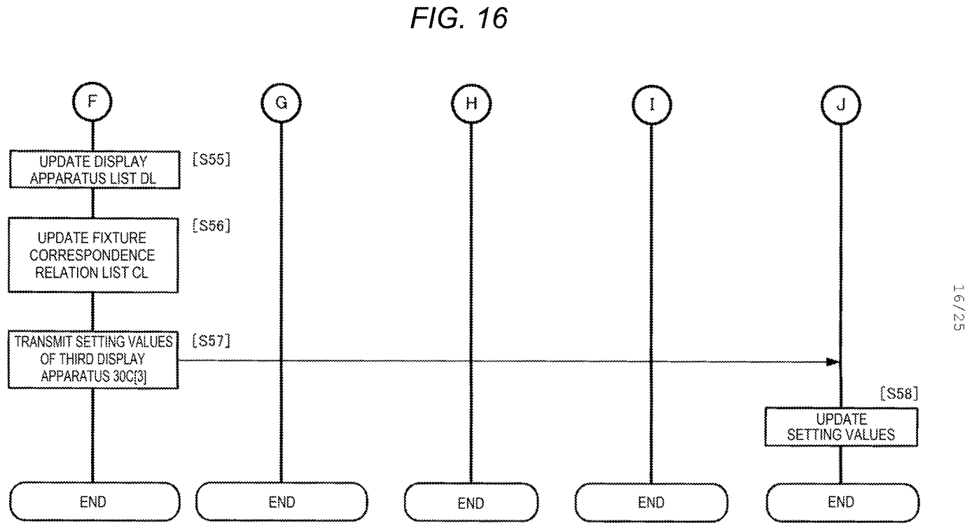

Hereinafter, a display system 1C according to a third embodiment is explained with reference to FIGS. 13 to 16. In order to simplify the explanation, hereinafter, differences of the display system 1C according to the third embodiment from the display system 1A according to the first embodiment and the display system 1B according to the second embodiment are mainly explained. Among elements provided in the display system 1C according to the third embodiment, the same elements as the elements provided in the display system 1A according to the first embodiment and the display system 1B according to the second embodiment are denoted by the same reference numerals and signs and explanation of functions of the elements is sometimes omitted.

In the display system 1A according to the first embodiment, it is assumed that the model numbers of the first display apparatus 30A[1] and the second display apparatus 30A[2] are the same. In the display system 1B according to the second embodiment, it is assumed that the model numbers of the first display apparatus 30A[1] and the second display apparatus 30B[2] are the same.

On the other hand, for example, when a rental company lends a display apparatus to the user, in the case of a failure of the first display apparatus 30A[1], the display apparatus 30 having the same model number as the first display apparatus 30A[1] may cannot be lent immediately. For that reason, in the third embodiment, a case in which the first display apparatus 30A[1] is replaced with a third display apparatus 30C[3] having a model number different from that of the first display apparatus 30A[1] is explained. 3-1: Configuration in the third embodiment

### 3-1-1: Overall Configuration

Compared with the display system 1A according to the first embodiment, the display system 1C according to the present embodiment includes a first information processing apparatus 10C instead of the first information processing apparatus 10A and includes a third display apparatus 30C[3] instead of the second display apparatus 30A[2]. In other respects, an overall configuration of the display system 1C according to the present embodiment is the same as the overall configuration of the display system 1A according to the first embodiment. Therefore, illustration of the overall configuration is omitted.

Hereinafter, the first information processing apparatus 10C and the third display apparatus 30C[3], which are the differences from the display system 1A according to the first embodiment, are mainly explained.

### 3-1-2: Configuration of the Third Display Apparatus

Since the third display apparatus 30C[3] has basically the same configuration as the second display apparatus 30A[2] according to the first embodiment illustrated in FIG. 3, illustration and explanation of the third display apparatus 30C[3] are omitted.

### 3-1-3: Configuration of the First Information Processing Apparatus

FIG. 13 is a block diagram illustrating a configuration example of the first information processing apparatus 10C according to the present embodiment. The first information processing apparatus 10C is different compared with the first information processing apparatus 10A according to the first embodiment in contents of the display apparatus list DL and the fixture installation history list SL. The first information processing apparatus 10C includes a calculator 116 in addition to the elements provided in the first information processing apparatus 10A.

The display apparatus list DL is a list concerning information including the identification information DI of the display apparatus 30, setting values, a name, and a model number of the display apparatus 30 identified by the identification information DI, a user name of a user who uses the display apparatus 30, and position information concerning relative coordinates of the fixture 70 and an optical axis of a projection lens of the display apparatus 30. The setting values are, as an example, one or more of a focal length, lens shift, a geometric correction value, lens zoom, and brightness of the display apparatus 30. Here, the setting values of the display apparatus 30 are an example of “setting information”.

Here, the relative coordinates of the fixture 70 and the optical axis of the projection lens of the display apparatus 30 indicate a relative positional relationship between a coordinate of an engagement part with the fixture 70 in the housing 35 of the display apparatus 30 and a coordinate of the center of the projection lens and is determined in advance by dimensional specifications of the display apparatus 30.

The fixture installation history list SL is a list indicating a history of the display apparatuses 30 attached to the fixture 70 identified by the identification information AI. As an example, the fixture installation history list SL is a list of information including the identification information AI of the fixture 70, update date and time information that is an attachment date and time of the display apparatus 30 having been attached to the fixture 70 identified by the identification information AI, position information concerning relative coordinates of the fixture 70 and the projection surface PF, and dimension information concerning a size of a projection area. The information included in the fixture installation history list SL is an example of the “setting history information”.

Here, the relative coordinates of the fixture 70 and the projection surface PF indicate a relationship of relative positions between a coordinate where the fixture 70 is installed in a space in which the display apparatus 30 is installed and a center coordinate of the projection surface PF and are measured and stored when the fixture 70 is installed.

The size of the projection area is a size of the projection surface PF and is determined in advance by the specifications of the projection surface PF.

The calculator 116 calculates setting values of the third display apparatus 30C[3] based on the position information concerning the relative coordinates of the fixture 70 and the projection surface PF, the dimension information concerning the size of the projection area, the position information concerning the relative coordinates of the fixture 70 and the optical axis of the projection lens, the model number of the third display apparatus 30C[3], and the position information concerning the relative coordinates of the fixture 70 and the optical axis of the projection lens of the third display apparatus 30C[3]. The position information concerning the relative coordinates of the fixture 70 and the projection surface PF and the dimension information concerning the size of the projection area are stored in the fixture installation history list SL as explained above. The position information concerning the relative coordinates of the fixture 70 and the optical axis of the projection lens, the model number of the third display apparatus 30C[3], and the position information concerning the relative coordinates of the fixture 70 and the optical axis of the projection lens of the third display apparatus 30C[3] are stored in the display apparatus list DL as explained above. The setting values of the third display apparatus 30C[3] are, as an example, one or more of a projection distance, lens shift, a geometric correction value, lens zoom, and brightness of the third display apparatus 30C[3].

Here, the projection distance means the distance between the projection lens of the third display apparatus 30C[3] and the projection surface PF. The lens shift means a relative positional relationship between a position where the optical axis of the third display apparatus 30C intersects the projection surface PF and the position of the center of the projection surface PF. Processing of setting the lens zoom includes processing of calculating a lens magnification based on the projection distance and the information concerning the size of the projection area and processing of determining the position of a lens based on the lens magnification.

The setting values of the third display apparatus 30C[3] are an example of the “setting information”.

### 3-2: Operation in the Third Embodiment

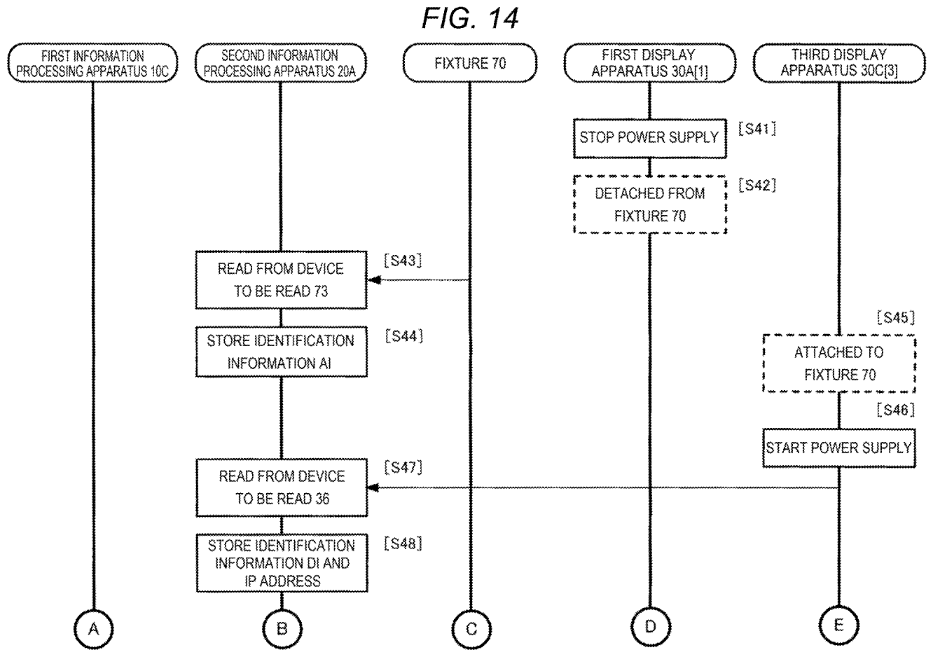

FIGS. 14 to 16 are sequence diagrams illustrating an operation example of the display system 1C according to the third embodiment. Note that, among steps explained below, steps that are manually performed and have low relevance to internal processing of the apparatuses are indicated by dotted line boxes in FIGS. 14 to 16.

Among operations illustrated in FIGS. 14 to 16, steps S41 to S49 are the same as steps S1 to S9 among the operations in the first embodiment illustrated in FIGS. 7 and 8 except that the second display apparatus 30A[2] is replaced with the third display apparatus 30C[3]. Therefore, explanation of the steps is omitted.

In step S50, the processing device 11 provided in the first information processing apparatus 10C functions as the determiner 115. The processing device 11 determines whether the identification information DI of the third display apparatus 30C[3] received in step S49 is registered in the display apparatus list DL. When the identification information DI of the third display apparatus 30C[3] is registered in the display apparatus list DL (“Y” in step S50), the processing device 11 executes processing in step S52. When the identification information DI of the third display apparatus 30C[3] is not registered in the display apparatus list DL (“N” in step S50), the processing device 11 executes processing in step S51.

In step S51, the processing device 11 provided in the first information processing apparatus 10C functions as the manager 113. The processing device 11 registers the identification information DI of the third display apparatus 30C[3] in the display apparatus list DL.

In step S52, the processing device 11 provided in the first information processing apparatus 10C functions as the acquirer 114. The processing device 11 acquires, from the fixture installation history list SL, position information concerning the relative coordinates of the fixture 70 and the projection surface PF and dimension information concerning the size of the projection area.

In step S53, the processing device 11 provided in the first information processing apparatus 10C functions as the acquirer 114. The processing device 11 acquires, from the display apparatus list DL, a model number correlated with the identification information DI of the third display apparatus 30C[3] and position information concerning relative coordinates of the fixture 70 and the optical axis of the projection lens of the third display apparatus 30C[3].

In step S54, the processing device 11 provided in the first information processing apparatus 10C functions as the calculator 116. The processing device 11 calculates setting values of the third display apparatus 30C[3] based on the position information concerning the relative coordinates of the fixture 70 and the projection surface PF and the dimension information concerning the size of the projection area acquired in step S52 and the position information concerning the relative coordinates of the fixture 70 and the optical axis of the projection lens of the third display apparatus 30C[3], the model number of the third display apparatus 30C[3], and the position information concerning the relative coordinates of the fixture 70 and the optical axis of the projection lens of the third display apparatus 30C[3] acquired in step S53.

In step S55, the processing device 11 provided in the first information processing apparatus 10C functions as the manager 113. The processing device 11 updates the display apparatus list DL by writing the setting values calculated in step S54 as setting values corresponding to the identification information DI of the third display apparatus 30C[3] in the display apparatus list DL.

In step S56, the processing device 11 provided in the first information processing apparatus 10C functions as the manager 113. The processing device 11 updates the fixture correspondence relation list CL by writing the identification information DI of the third display apparatus 30C[3] as the identification information DI of the display apparatus 30 correlated with the identification information AI of the fixture 70 in the fixture correspondence relation list CL.

In step S57, the processing device 11 provided in the first information processing apparatus 10C functions as the communication controller 111. The processing device 11 transmits the setting values calculated in step S54 to the third display apparatus 30C[3] as setting values of the third display apparatus 30C[3]. At this time, the processing device 11 transmits the setting values of the third display apparatus 30C[3] to the third display apparatus 30C[3] using the IP address of the third display apparatus 30C[3] received in step S49.

The processing device 32 provided in the third display apparatus 30C[3] functions as the communication controller 321. The processing device 32 receives the setting values of the third display apparatus 30C[3] from the first information processing apparatus 10C.

In step S58, the processing device 32 provided in the third display apparatus 30C[3] updates the setting values of the third display apparatus 30C[3] using the setting values received in step S57.

Note that the order of the operations in steps S41 to S58 in FIGS. 14 to 16 may be changed as appropriate within a range in which an operation in the entire display system 1C is not hindered.

In the sequence explained above, step S41 and step S42 are equivalent to the “detachment procedure for the first display apparatus 30A[1]”. Steps S43 and S44 are equivalent to the “reading procedure for the fixture 70”. Step S45 and step S46 are equivalent to an “attachment procedure for the third display apparatus 30C[3]”. Steps S47 to S58 are equivalent to a “setting parameter determination procedure for the third display apparatus 30C[3]”.

That is, in the sequence according to the first embodiment and the sequence according to the present embodiment, the “setting parameter determination procedure for the second display apparatus 30A[2]” and the “setting parameter determination procedure for the third display apparatus 30C[3]” are different and, on the other hand, the other procedures are the same.

### 4: Fourth Embodiment

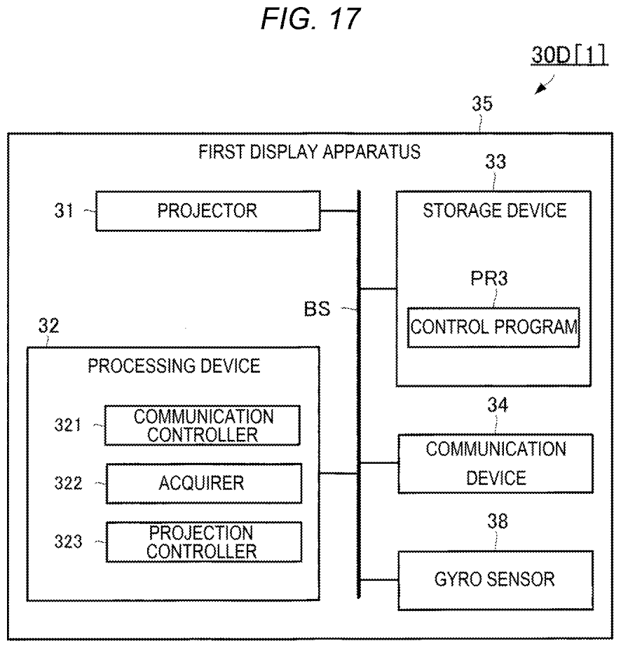

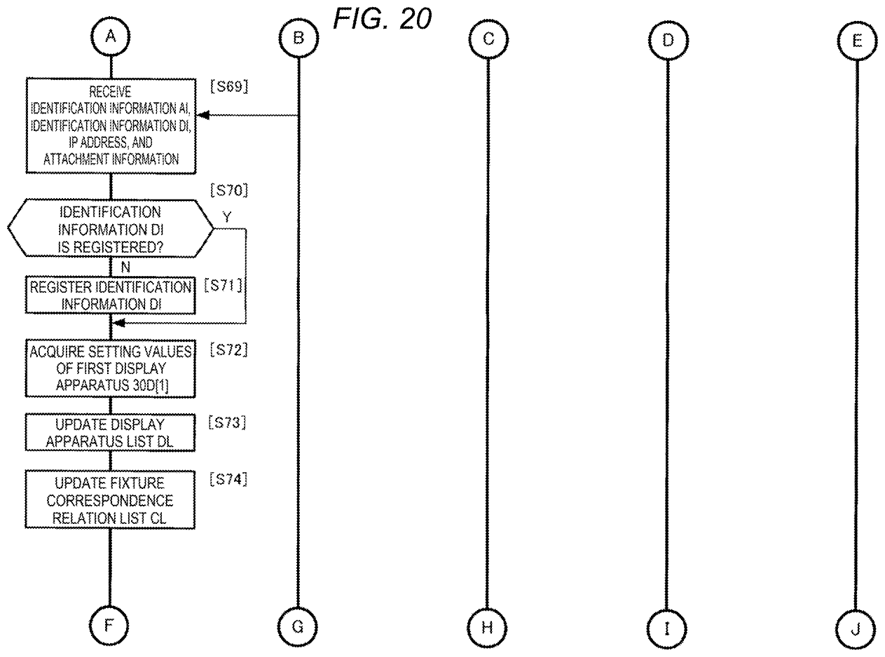

Hereinafter, a display system 1D according to a fourth embodiment is explained with reference to FIGS. 17 to 20. In order to simplify the explanation, hereinafter, differences of the display system 1D according to the fourth embodiment from the display system 1A according to the first embodiment, the display system 1B according to the second embodiment, and the display system 1C according to the third embodiment are mainly explained. Among elements provided in the display system 1D according to the fourth embodiment, the same elements as the elements provided in the display system 1A according to the first embodiment, the display system 1B according to the second embodiment, and the display system 1C according to the third embodiment are denoted by the same reference numerals and signs and explanation of functions of the elements is sometimes omitted.

In the display system 1A according to the first embodiment, as an example, the setting values of the lens shift of the first display apparatus 30A[1] are written as the setting values of the lens shift of the second display apparatus 30A[2] and the display apparatus list DL is updated. On the other hand, when the fixture 70 has a physical angle adjustment mechanism, it is unnecessary to adjust the position of the projection image PP only with the lens shift. A larger projection image PP can be projected onto the projection surface PF.

For that reason, in the fourth embodiment, a case in which a first display apparatus 30D[1] is replaced with a second display apparatus 30D[2] on the premise that the first display apparatus 30D[1] and the second display apparatus 30D[2] include gyro sensors 38 is explained.

### 4-1: Configuration in the Fourth Embodiment

### 4-1-1: Overall Configuration

Compared with the display system 1A according to the first embodiment, the display system 1D according to the present embodiment includes a first information processing apparatus 10D instead of the first information processing apparatus 10A, includes the first display apparatus 30D[1] instead of the first display apparatus 30A[1], and includes the second display apparatus 30D[2] instead of the second display apparatus 30A[2]. In other respects, an overall configuration of the display system 1D according to the present embodiment is the same as the overall configuration of the display system 1A according to the first embodiment. Therefore, illustration of the overall configuration is omitted.

Hereinafter, the first information processing apparatus 10D, the first display apparatus 30D[1], and the second display apparatus 30D[2], which are differences from the display system 1A according to the first embodiment, are mainly explained. 4-1-2: Configuration of the first display apparatus

FIG. 17 is a block diagram illustrating a configuration example of the first display apparatus 30D[1]. The first display apparatus 30D[1] includes the gyro sensor 38 in addition to the elements provided in the first display apparatus 30A[1] according to the first embodiment.

The gyro sensor 38 is a sensor that detects a posture of the first display apparatus 30D[1]. As an example, the gyro sensor 38 detects a roll angle, a pitch angle, and a yaw angle relating to the posture of the first display apparatus 30D[1].

### 4-1-3: Configuration of the Second Display Apparatus

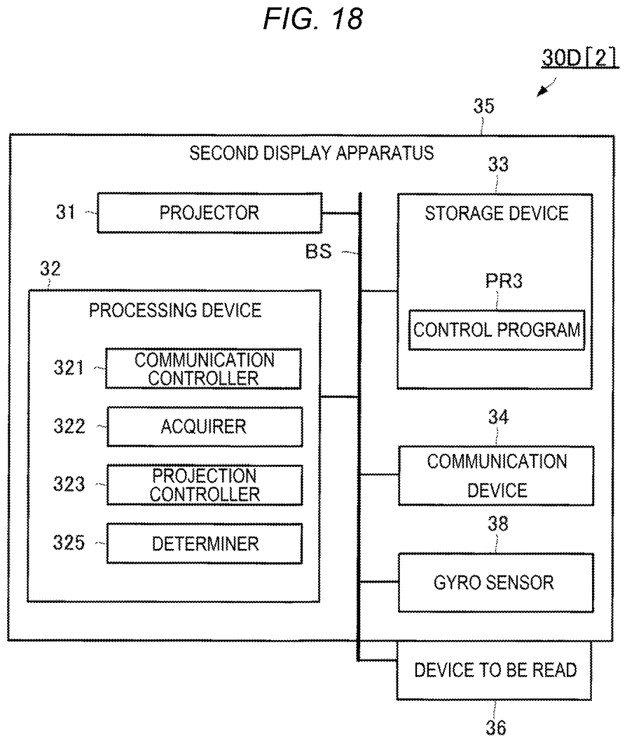

FIG. 18 is a block diagram illustrating a configuration example of the second display apparatus 30D[2]. The second display apparatus 30D[2] includes the gyro sensor 38 and a determiner 325 in addition to the elements provided in the second display apparatus 30A[2] according to the first embodiment.

Since the gyro sensor 38 is the same gyro sensor as the gyro sensor 38 provided in the first display apparatus 30D[1], explanation of the gyro sensor 38 is omitted.

The determiner 325 determines whether a set of a roll angle, a pitch angle, and a yaw angle relating to a posture of the second display apparatus 30D[2] serving as setting values transmitted from the first information processing apparatus 10D and set in the second display apparatus 30D[2] and a set of a roll angle, a pitch angle, and a yaw angle relating to the posture of the second display apparatus 30D[2] detected by the gyro sensor 38 coincide.

When a determination result by the determiner 325 is affirmative, the communication controller 321 transmits a posture adjustment end request to the first information processing apparatus 10D. When the determination result by the determiner 325 is negative, the communication controller 321 transmits, to the first information processing apparatus 10D, a difference between the set of the roll angle, the pitch angle, and the yaw angle relating to the posture of the second display apparatus 30D[2] serving as the setting values and the set of the roll angle, the pitch angle, and the yaw angle relating to the posture of the second display apparatus 30D[2] detected by the gyro sensor 38. 4-1-4: Configuration of the first information processing apparatus

Since a configuration of the first information processing apparatus 10D is generally the same as the configuration of the first information processing apparatus 10A illustrated in FIG. 5, illustration of the configuration is omitted.

In the first information processing apparatus 10D, the communication controller 111 has the same function as the communication controller 111 provided in the first information processing apparatus 10A.

Further, the communication controller 111 provided in the first information processing apparatus 10D transmits a posture adjustment start request to the second display apparatus 30D[2].

When a determination result by the determiner 325 is affirmative, the communication controller 111 receives a posture adjustment end request from the second display apparatus 30D[2]. Further, the communication controller 111 transmits a posture adjustment end request to the second information processing apparatus 20A.

On the other hand, when the determination result by the determiner 325 is negative, the communication controller 111 receives the difference from the second display apparatus 30D[2]. Further, the communication controller 111 transmits the difference to the second information processing apparatus 20A.

In the first information processing apparatus 10D, the display controller 112 has the same function as the display controller 112 provided in the first information processing apparatus 10A.

Furthermore, the display controller 112 provided in the first information processing apparatus 10D causes the display device 23 provided in the second information processing apparatus 20A to display a posture adjustment screen.

### 4-2: Operation in the Fourth Embodiment

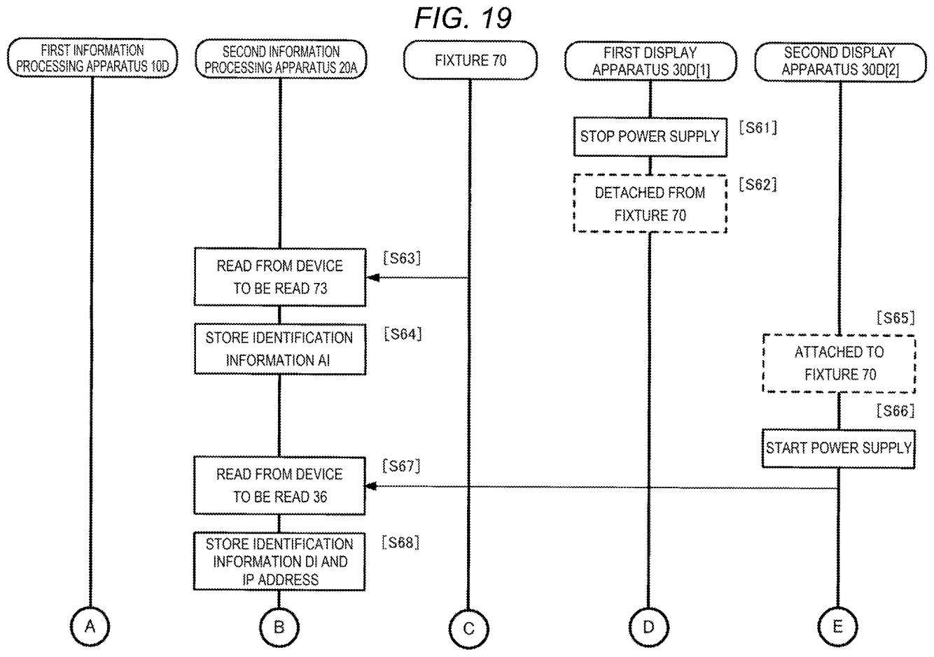

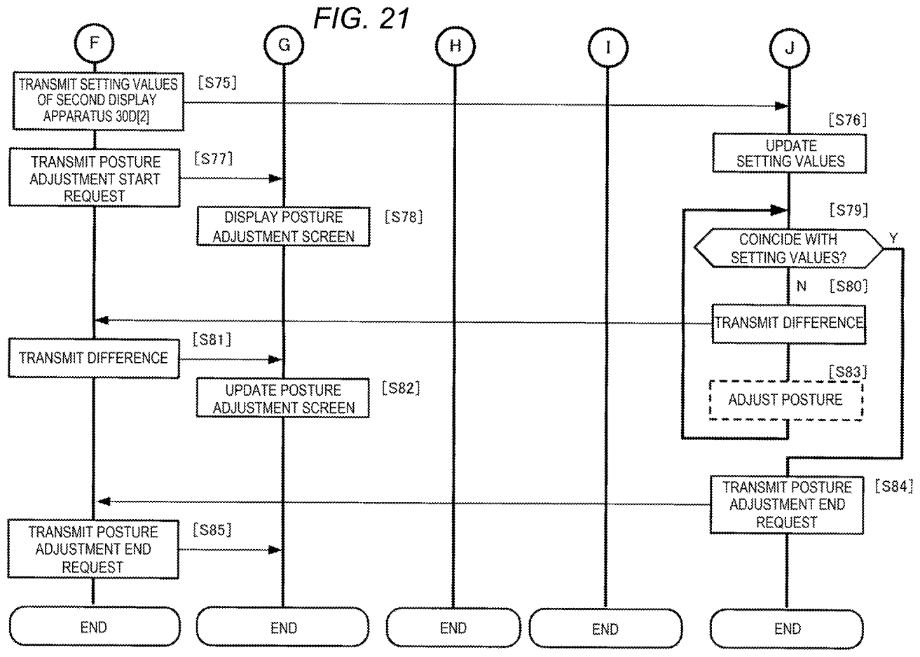

FIGS. 19 to 21 are sequence diagrams illustrating an operation example of the display system 1D according to the fourth embodiment. Note that, among steps explained below, steps that are manually performed and have low relevance to internal processing of the apparatuses are indicated by dotted line boxes in FIGS. 19 to 21.

Among operations illustrated in FIGS. 19 to 21, steps S61 to S69 are the same as steps S1 to S9 among the operations in the first embodiment illustrated in FIGS. 7 and 8. Therefore, explanation of the steps is omitted.

In step S70, the processing device 11 provided in the first information processing apparatus 10D functions as the determiner 115. The processing device 11 determines whether the identification information DI of the second display apparatus 30D[2] received in step S69 is registered in the display apparatus list DL. When the identification information DI of the second display apparatus 30D[2] is registered in the display apparatus list DL (“Y” in step S70), the processing device 11 executes processing in step S72. When the identification information DI of the second display apparatus 30D[2] is not registered in the display apparatus list DL (“N” in step S70), the processing device 11 executes processing in step S71.

In step S71, the processing device 11 provided in the first information processing apparatus 10D functions as the manager 113. The processing device 11 registers the identification information DI of the second display apparatus 30D[2] in the display apparatus list DL.

In step S72, the processing device 11 provided in the first information processing apparatus 10D functions as the acquirer 114. The processing device 11 acquires setting values of the first display apparatus 30D[1] by referring to the fixture installation history list SL using the identification information AI received in step S69. As explained above, the setting values are specifically the roll angle, the pitch angle, the yaw angle, the focal length, the lens shift, the geometric correction value, the lens zoom, the brightness, and the like relating to the posture of the first display apparatus 30D[1]. The roll angle, the pitch angle, and the yaw angle are detected by the gyro sensor 38 of the first display apparatus 30D[1].

In step S73, the processing device 11 provided in the first information processing apparatus 10D functions as the manager 113. The processing device 11 updates the display apparatus list DL by writing the setting values of the first display apparatus 30D[1] acquired in step S72 as setting values corresponding to the identification information DI of the second display apparatus 30D[2] in the display apparatus list DL.

In step S74, the processing device 11 provided in the first information processing apparatus 10D functions as the manager 113. The processing device 11 updates the fixture correspondence relation list CL by writing the identification information DI of the second display apparatus 30D[2] as the identification information DI of the display apparatus 30 correlated with the identification information AI of the fixture 70 in the fixture correspondence relation list CL.

In step S75, the processing device 11 provided in the first information processing apparatus 10D functions as the communication controller 111. The processing device 11 transmits the setting values of the second display apparatus 30D[2] written in the display apparatus list DL in step S73 to the second display apparatus 30D[2]. At this time, the processing device 11 transmits the setting values of the second display apparatus 30D[2] to the second display apparatus 30D[2] using the IP address of the second display apparatus 30D[2] received in step S69.

The processing device 32 provided in the second display apparatus 30D[2] functions as the communication controller 321. The processing device 32 receives the setting values of the second display apparatus 30D[2] from the first information processing apparatus 10D.

In step S76, the processing device 32 provided in the second display apparatus 30D[2] updates the setting values of the second display apparatus 30D[2] using the setting values received in step S75.

In step S77, the processing device 11 provided in the first information processing apparatus 10D functions as the communication controller 111. The processing device 11 transmits a posture adjustment start request to the second information processing apparatus 20A.

The processing device 21 provided in the second information processing apparatus 20A functions as the communication controller 211. The processing device 21 receives the posture adjustment start request from the first information processing apparatus 10D.

In step S78, the display device 23 provided in the second information processing apparatus 20A displays a posture adjustment screen. More specifically, in step S78, the processing device 11 provided in the first information processing apparatus 10D functions as the display controller 112. The processing device 11 causes the display device 23 provided in the second information processing apparatus 20A to display the posture adjustment screen.

In step S79, the processing device 32 provided in the second display apparatus 30D[2] functions as the determiner 325. The processing device 32 determines whether the set of the roll angle, the pitch angle, and the yaw angle relating to the posture of the second display apparatus 30D[2] serving as the setting values and the set of the roll angle, the pitch angle, and the yaw angle relating to the posture of the second display apparatus 30D[2] detected by the gyro sensor 38 coincide.

When all the angles in both the sets coincide (“Y” in step S79), the processing device 32 executes processing in step S84. On the other hand, when angles that do not coincide are present among the angles in both the sets (“N” in step S79), the processing device 32 executes processing in step S80.

In step S80, the processing device 32 provided in the second display apparatus 30D[2] functions as the communication controller 321. The processing device 32 transmits, to the first information processing apparatus 10D, a difference between the set of the roll angle, the pitch angle, and the yaw angle relating to the posture of the second display apparatus 30D[2] serving as the setting values and the set of the roll angle, the pitch angle, and the yaw angle relating to the posture of the second display apparatus 30D[2] detected by the gyro sensor 38.

The processing device 11 provided in the first information processing apparatus 10D functions as the communication controller 111. The processing device 11 receives the difference from the second display apparatus 30D[2].

In step S81, the processing device 11 provided in the first information processing apparatus 10D functions as the communication controller 111. The processing device 11 transmits the difference to the second information processing apparatus 20A.

The processing device 21 provided in the second information processing apparatus 20A functions as the communication controller 211. The processing device 21 receives the difference from the first information processing apparatus 10D.

In step S82, the display device 23 provided in the second information processing apparatus 20A updates the posture adjustment screen. More specifically, in step S82, the processing device 11 provided in the first information processing apparatus 10D functions as the display controller 112. The processing device 11 updates the posture adjustment screen on the display device 23 provided in the second information processing apparatus 20A. The difference is displayed on the updated posture adjustment screen.

In step S83, a user or an operator manually adjusts a posture of the second display apparatus 30D[2] while checking the posture adjustment screen on which the difference is displayed. While being triggered by the gyro sensor 38 detecting a change in the posture of the second display apparatus 30D[2], the processing device 32 provided in the second display apparatus 30D[2] executes the processing in step S79.

In step S84, the processing device 32 provided in the second display apparatus 30D[2] functions as the communication controller 321. The processing device 32 transmits a posture adjustment end request to the first information processing apparatus 10D.

The processing device 11 provided in the first information processing apparatus 10D functions as the communication controller 111. The processing device 11 receives the posture adjustment end request from the second display apparatus 30D[2].

In step S85, the processing device 11 provided in the first information processing apparatus 10D functions as the communication controller 111. The processing device 11 transmits a posture adjustment end request to the second information processing apparatus 20A.

The processing device 21 provided in the second information processing apparatus 20A functions as the communication controller 211. The processing device 21 receives the posture adjustment end request from the first information processing apparatus 10D. The processing device 21 switches the posture adjustment screen displayed on the display device 23 to another screen.

The order of the operations in steps S61 to S84 in FIGS. 19 to 21 may be changed as appropriate within a range in which an operation in the entire display system 1D is not hindered.

In the sequence explained above, step S61 and step S62 are equivalent to a “detachment procedure for the first display apparatus 30D[1]”. Steps S63 and S64 are equivalent to the “reading procedure for the fixture 70”. Step S65 and step S66 are equivalent to an “attachment procedure for the second display apparatus 30D[2]”. Steps S67 to S84 are equivalent to the “setting parameter determination procedure for the second display apparatus 30D[2]”.

That is, in the sequence according to the first embodiment and the sequence according to the present embodiment, the “setting parameter determination procedure for the second display apparatus 30A[2]” and the “setting parameter determination procedure for the second display apparatus 30D[2]” are different and, on the other hand, the other procedures are the same.

### 5: Fifth Embodiment

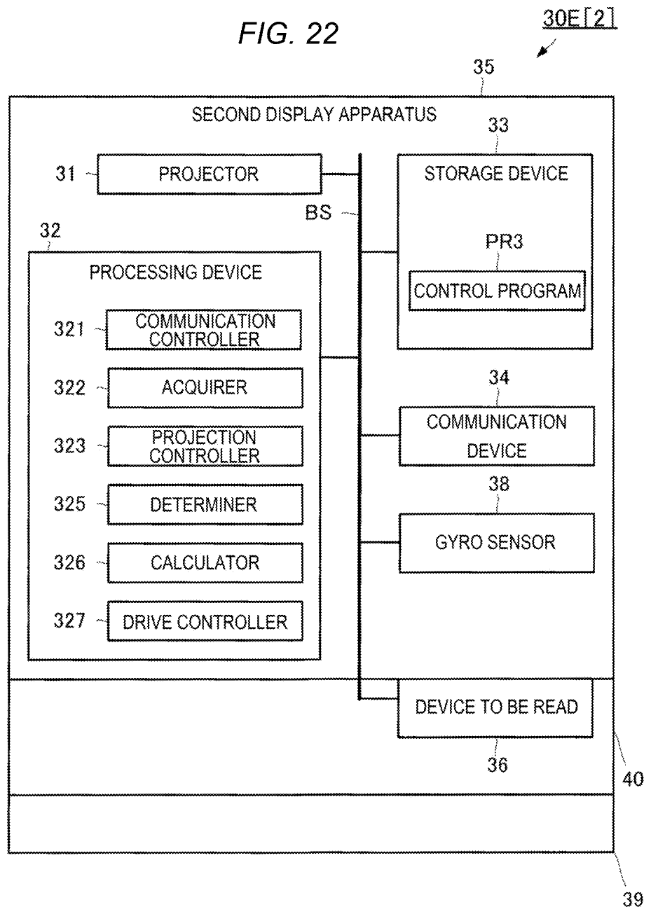

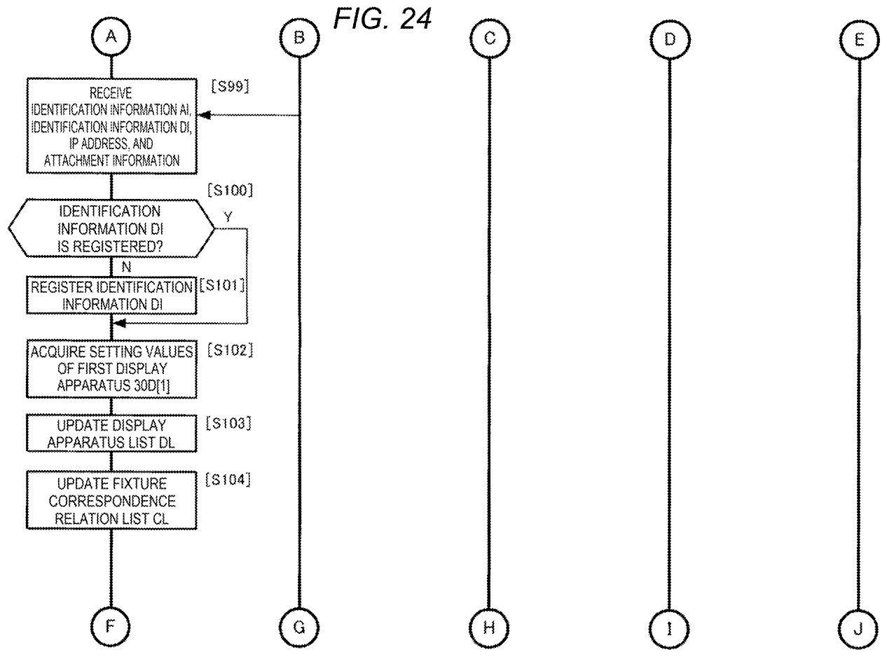

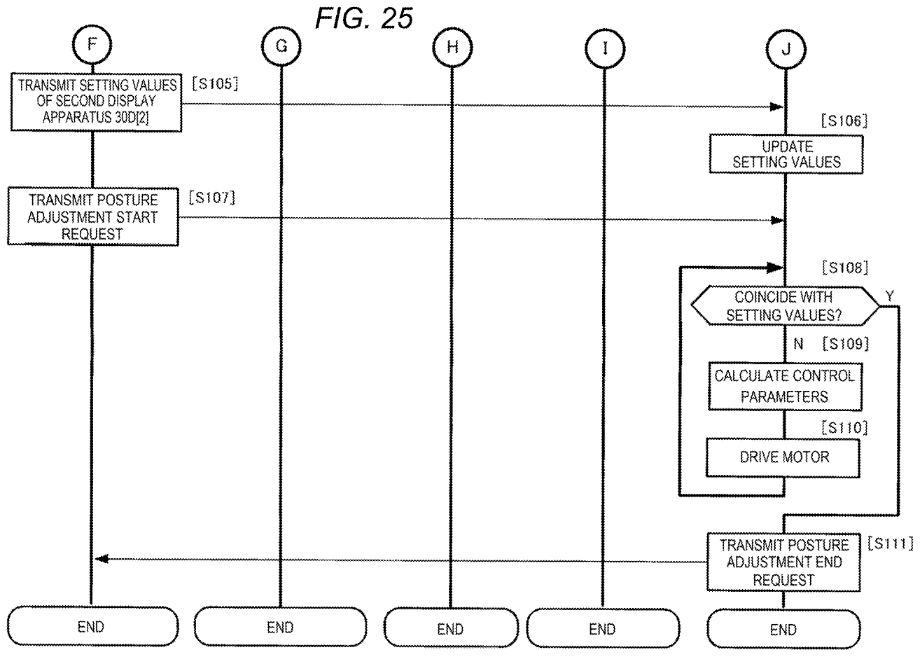

Hereinafter, a display system 1E according to a fifth embodiment is explained with reference to FIGS. 22 to 25. In order to simplify the explanation, hereinafter, differences of the display system 1E according to the fifth embodiment from the display system 1A according to the first embodiment, the display system 1B according to the second embodiment, the display system 1C according to the third embodiment, and the display system 1D according to the fourth embodiment are mainly explained. Among elements provided in the display system 1E according to the fifth embodiment, the same elements as the elements provided in the display system 1A according to the first embodiment, the display system 1B according to the second embodiment, the display system 1C according to the third embodiment, and the display system 1D according to the fourth embodiment are denoted by the same reference numerals and signs and explanation of functions of the elements is sometimes omitted.

In the display system 1D according to the fourth embodiment, the user or the operator manually adjusts the posture of the second display apparatus 30D[2] while checking the posture adjustment screen. On the other hand, the second display apparatus 30D[2] sometimes includes a posture changing mechanism. For that reason, in the display system 1E according to the fifth embodiment, work of replacing the first display apparatus 30D[1] with a second display apparatus 30E[2] is explained on the premise that the second display apparatus 30E[2] includes the posture changing mechanism.

### 5-1: Configuration in the Fifth Embodiment

### 5-1-1: Overall Configuration

Compared with the display system 1D according to the fourth embodiment, the display system 1E according to the present embodiment includes the second display apparatus 30E[2] instead of the second display apparatus 30D[2]. In other respects, an overall configuration of the display system 1E according to the present embodiment is the same as the overall configuration of the display system 1D according to the fourth embodiment. Therefore, illustration of the overall configuration is omitted.

Hereinafter, the second display apparatus 30E[2], which is a difference from the display system 1D according to the fourth embodiment, is mainly explained.

### 5-1-2: Configuration of the Second Display Apparatus

FIG. 22 is a block diagram illustrating a configuration example of the second display apparatus 30E[2] according to the present embodiment. The second display apparatus 30E[2] according to the present embodiment further includes a pedestal 39, a posture changing mechanism 40, a calculator 326, and a drive controller 327 in addition to the elements provided in the second display apparatus 30D[2] according to the fourth embodiment.

The pedestal 39 is engaged with the fixing section 72 of the fixture 70.

The posture changing mechanism 40 includes a first motor and a second motor. The first motor rotates the pedestal 39 with respect to the fixing section 72 of the fixture 70. The second motor rotates the housing 35 with respect to the pedestal 39.

The calculator 326 calculates control parameters for the first motor and the second motor based on a difference between a set of a pitch angle and a yaw angle relating to a posture of the second display apparatus 30E[2] serving as setting values of the second display apparatus 30E[2] and a set of a pitch angle and a yaw angle relating to a posture of the second display apparatus 30E[2] detected by the gyro sensor 38.

The drive controller 327 drives the first motor and the second motor based on the control parameters calculated by the calculator 326.

### 5-2: Operation in the Fifth Embodiment

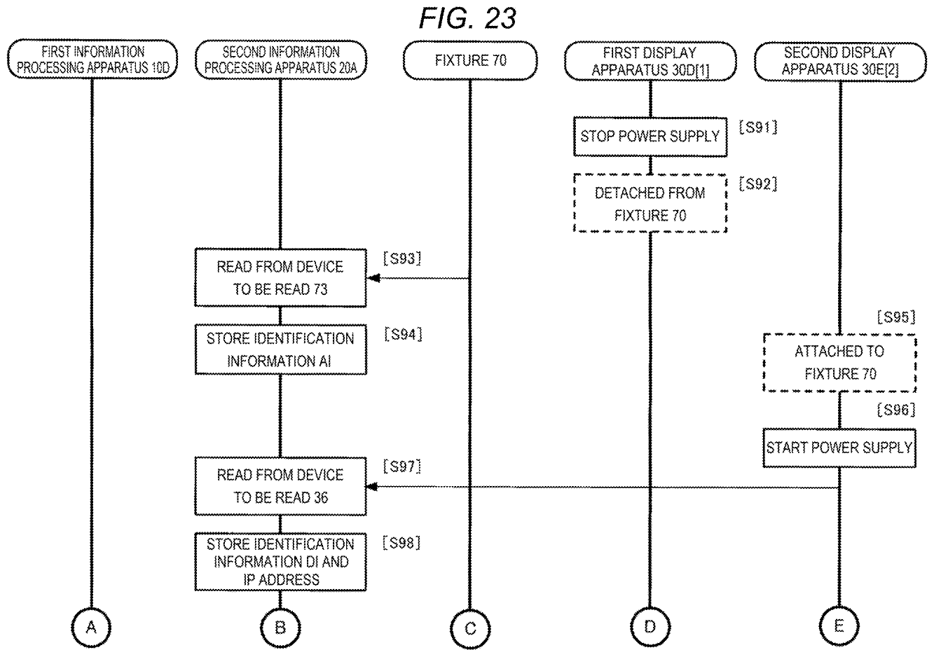

FIGS. 23 to 25 are sequence diagrams illustrating an operation example of the display system 1E according to the fifth embodiment. Note that, among steps explained below, steps that are manually performed and have low relevance to internal processing of the apparatuses are indicated by dotted line boxes in FIGS. 23 to 25.

Among operations illustrated in FIGS. 23 to 25, steps S91 to S106 are the same as steps S61 to S76 in the operations in the fourth embodiment illustrated in FIGS. 19 to 21. Therefore, explanation of the steps is omitted.

In step S107, the processing device 11 provided in the first information processing apparatus 10D functions as the communication controller 111. The processing device 11 transmits a posture adjustment start request to the second display apparatus 30E[2].

The processing device 32 provided in the second display apparatus 30E[2] functions as the communication controller 321. The processing device 32 receives the posture adjustment start request from the first information processing apparatus 10D.

In step S108, the processing device 32 provided in the second display apparatus 30E[2] functions as the determiner 325. The processing device 32 determines whether the set of the pitch angle and the yaw angle relating to the posture of the second display apparatus 30E[2] serving as setting values and the set of the pitch angle and the yaw angle relating to the posture of the second display apparatus 30E[2] detected by the gyro sensor 38 coincide.

When all the angles in both sets coincide (“Y” in step S108), the processing device 32 executes the processing in step S111. On the other hand, when angles that do not coincide are present among the angles in both the sets (“N” in step S108), the processing device 32 executes processing in step S109.

In step S109, the processing device 32 provided in the second display apparatus 30E[2] functions as the calculator 326. The processing device 32 calculates control parameters of the first motor and the second motor based on a difference between the set of the pitch angle and the yaw angle relating to the posture of the second display apparatus 30E[2] serving as the setting values of the second display apparatus 30E[2] and the set of the pitch angle and the yaw angle relating to the posture of the second display apparatus 30E[2] detected by the gyro sensor 38.

In step S110, the processing device 32 provided in the second display apparatus 30E[2] functions as the drive controller 327. The processing device 32 drives the first motor and the second motor based on the control parameters calculated in step S109.

In step S111, the processing device 32 provided in the second display apparatus 30E[2] functions as the communication controller 321. The processing device 32 transmits a posture adjustment end request to the first information processing apparatus 10D.

The processing device 11 provided in the first information processing apparatus 10D functions as the communication controller 111. The processing device 11 receives the posture adjustment end request from the second display apparatus 30E[2].

The order of the operations in steps S91 to S111 in FIGS. 23 to 25 may be changed as appropriate within a range in which an operation in the entire display system 1E is not hindered.

In the sequence explained above, step S91 and step S92 are equivalent to the “detachment procedure for the first display apparatus 30D[1]”. Step S93 and step S94 are equivalent to the “reading procedure for the fixture 70”. Steps S95 and S96 are equivalent to an “attachment procedure for the second display apparatus 30E[2]”. Steps S97 to S111 are equivalent to a “setting parameter determination procedure for the second display apparatus 30E[2]”.

That is, in the sequence according to the fourth embodiment and the sequence according to the present embodiment, the “setting parameter determination procedure for the second display apparatus 30D[2]” and the “setting parameter determination procedure for the second display apparatus 30E[2]” are different and, on the other hand, the other procedures are the same.

### 6: Modifications

The embodiments explained above can be variously modified. Specific aspects of modifications are exemplified below. The aspects exemplified below and the aspects explained in the embodiments above can be combined as appropriate without contradicting each other. Note that, in the modifications exemplified below, elements having action and functions equivalent to those in the embodiments are denoted by the reference numerals and signs referred to in the above explanation and detailed explanation of the respective elements is omitted as appropriate.

### 6-1: Modification 1

In the first embodiment, the first display apparatus 30A[1] and the second display apparatus 30A[2] are the projection apparatuses that project the projection image PP onto the projection surface PF. However, the first display apparatus 30A[1] and the second display apparatus 30A[2] may be displays.

### 7: Summary of the Present Disclosure

A summary of the present disclosure is appended below.
(Appendix 1) A setting method for a display apparatus, including: storing, with a first information processing apparatus, identification information of a fixture and setting history information including setting information of a first display apparatus in correlation with each other; and communicating, with a second information processing apparatus connected to the first information processing apparatus via a network, with the fixture using near field communication, wherein the first display apparatus and a second display apparatus different from the first display apparatus are attachable to the fixture.

With the configuration explained above, the identification information of the fixture to which the first display apparatus and the second display apparatus can be attached and the setting history information including the setting information of the first display apparatus are stored in correlation with each other. Accordingly, after a display apparatus attached to an installation space is replaced with another display apparatus, compared with the related art, a burden of setting work for a display apparatus attached to the installation space anew can be reduced for a user of the display apparatus or an operator who replaces the display apparatus.

More specifically, after the second display apparatus is attached to the fixture, work of the user of the display apparatus or the operator who replaces the display apparatus setting the setting information of the second display apparatus is shortened and a burden on the user or the operator is reduced.
(Appendix 2) The setting method for the display apparatus described in Appendix 1, further including: connecting, with the second display apparatus, to a network to which the first information processing apparatus is connected; communicating, with the second information processing apparatus, with the second display apparatus using the near field communication; and storing, with the first information processing apparatus, network address information of the second display apparatus.

With the configuration explained above, since the network address information of the second display apparatus is stored by the first information processing apparatus, the first information processing apparatus can acquire the network address information of the second display apparatus from the second display apparatus through the second information processing apparatus. The second display apparatus can store the setting information of the second display apparatus without processing of registering the second display apparatus being executed by the first information processing apparatus. For that reason, it is possible to prevent replacement work from being delayed because of a load status of the first information processing apparatus.
(Appendix 3) The setting method for the display apparatus described in Appendix 1 or Appendix 2, further including: storing, with the second information processing apparatus, the setting information of the second display apparatus; and communicating, with the second display apparatus, with the second information processing apparatus using the near field communication.

With the configuration explained above, since the second information processing apparatus stores the setting information of the second display apparatus and communicates with the second information processing apparatus using the near field communication, the second display apparatus can store the setting information acquired from the first information processing apparatus through the second information processing apparatus even before the second display apparatus is connected to a server via the network. For that reason, a degree of freedom is generated in a procedure of the replacement work for the display apparatus.
(Appendix 4) The setting method for the display apparatus described in any one of Appendices 1 to 3, wherein the setting information of the first display apparatus includes posture information of the first display apparatus in a state where the first display apparatus is installed on the fixture, and the setting method further includes: storing, with the second information processing apparatus, the setting information of the second display apparatus; and outputting, with the second information processing apparatus, a posture adjustment screen for the second display apparatus based on the posture information.

With the configuration explained above, the user of the display apparatus or the operator who replaces the display apparatus can set, based on the posture adjustment screen, a relative positional relationship of the second display apparatus with respect to a projection surface.
(Appendix 5) The setting method for the display apparatus described in any one of Appendices 1 to 4, wherein the setting information of the first display apparatus includes posture information of the first display apparatus in a state where the first display apparatus is installed on the fixture, and the setting method further includes: storing, with the second display apparatus, the setting information of the second display apparatus; and storing, with the second display apparatus, a control parameter of a posture changing mechanism provided in the second display apparatus, the control parameter being generated based on the posture information.

With the configuration described above, the second display apparatus can set a relationship of a relative position of the second display apparatus with respect to a projection surface by driving the posture changing mechanism.
(Appendix 6) A processing method for an information processing apparatus, including: storing identification information of a fixture and setting history information including setting information of a first display apparatus attachable to the fixture in correlation with each other; acquiring the identification information of the fixture, identification information of a second display apparatus different from the first display apparatus and attachable to the fixture, and setting information of the second display apparatus; and storing the setting information of the second display apparatus based on the setting history information in correlation with the identification information of the fixture.

With the configuration explained above, compared with the related art, a burden of setting work after replacement of the display apparatus is lighter for a user of the display apparatus or an operator who replaces the display apparatus.

More specifically, after the second display apparatus is attached to the fixture, work of the user of the display apparatus or the operator who replaces the display apparatus setting the setting information of the second display apparatus is shortened and a burden on the user or the operator is reduced.
(Appendix 7) The processing method for the information processing apparatus described in Appendix 6, further including: storing the identification information of the fixture and position information concerning relative positions of the fixture and a projection surface in correlation with each other; and generating setting information of the second display apparatus based on the setting history information and the position information.

With the configuration explained above, even when a model number of the second display apparatus is different from a model number of the first display apparatus, after the user of the display apparatus or the operator who replaces the display apparatus attaches the second display apparatus to the fixture, the work of the operator setting the setting information of the second display apparatus is shortened and the burden on the operator is reduced.
(Appendix 8) a Processing Method for an information processing apparatus, including: storing identification information of a fixture and position information concerning relative positions of the fixture and a projection surface in correlation with each other; storing the identification information of the fixture and dimension information concerning a size of a projection image projected onto the projection surface in correlation with each other; acquiring the identification information of the fixture, identification information of a second display apparatus attachable to the fixture, and setting information of the second display apparatus; and storing the setting information of the second display apparatus based on the position information and the dimension information in correlation with the identification information of the fixture.

With the configuration explained above, compared with the related art, a burden of setting work after replacement of the display apparatus is lighter for a user of the display apparatus or an operator who replaces the display apparatus.

More specifically, after the second display apparatus is attached to the fixture, work of the user of the display apparatus or the operator who replaces the display apparatus setting the setting information of the second display apparatus is shortened and a burden on the user or the operator is reduced.

What is claimed is:

1. A setting method for a display apparatus, comprising:
storing, with a first information processing apparatus, identification information of a fixture and setting history information including setting information of a first display apparatus in correlation with each other; and
communicating, with a second information processing apparatus connected to the first information processing apparatus via a network, with the fixture using near field communication, wherein
the first display apparatus and a second display apparatus different from the first display apparatus are attachable to the fixture.

2. The setting method for the display apparatus according to claim 1, further comprising:
connecting, with the second display apparatus, to a network to which the first information processing apparatus is connected;
communicating, with the second information processing apparatus, with the second display apparatus using the near field communication; and
storing, with the first information processing apparatus, network address information of the second display apparatus.

3. The setting method for the display apparatus according to claim 1, further comprising:
storing, with the second information processing apparatus, the setting information of the second display apparatus; and
communicating, with the second display apparatus, with the second information processing apparatus using the near field communication.

4. The setting method for the display apparatus according to claim 1, wherein
the setting information of the first display apparatus includes posture information of the first display apparatus in a state where the first display apparatus is installed on the fixture, and
the setting method further comprises:
storing, with the second information processing apparatus, the setting information of the second display apparatus; and
outputting, with the second information processing apparatus, a posture adjustment screen for the second display apparatus based on the posture information.

5. The setting method for the display apparatus according to claim 1, wherein
the setting information of the first display apparatus includes posture information of the first display apparatus in a state where the first display apparatus is installed on the fixture, and
the setting method further comprises:
storing, with the second display apparatus, the setting information of the second display apparatus; and
storing, with the second display apparatus, a control parameter of a posture changing mechanism provided in the second display apparatus, the control parameter being generated based on the posture information.

6. A processing method for an information processing apparatus, comprising:
storing identification information of a fixture and setting history information including setting information of a first display apparatus attachable to the fixture in correlation with each other;
acquiring the identification information of the fixture, identification information of a second display apparatus different from the first display apparatus and attachable to the fixture, and setting information of the second display apparatus; and
storing the setting information of the second display apparatus based on the setting history information in correlation with the identification information of the fixture.

7. The processing method for the information processing apparatus according to claim 6, further comprising:
storing the identification information of the fixture and position information concerning relative positions of the fixture and a projection surface in correlation with each other; and
generating setting information of the second display apparatus based on the setting history information and the position information.

8. A processing method for an information processing apparatus, comprising:
storing identification information of a fixture and position information concerning relative positions of the fixture and a projection surface in correlation with each other;
storing the identification information of the fixture and dimension information concerning a size of a projection image projected onto the projection surface in correlation with each other;
acquiring the identification information of the fixture, identification information of a second display apparatus attachable to the fixture, and setting information of the second display apparatus; and
storing the setting information of the second display apparatus based on the position information and the dimension information in correlation with the identification information of the fixture.
